(19) United States
(12) Patent Application Publication
(10) Pub. No.: US 2025/0077973 A1
(43) Pub. Date: Mar. 6, 2025

(54) SYSTEM AND METHOD FOR SELECTIVELY RECOMMENDING A MACHINING STRATEGY FOR MACHINING A FEATURE FROM A WORKPIECE & MONITORING PERFORMANCE OF MACHINING PROCESSES

(71) Applicant: Lambda Function, Inc., Brentwood, CA (US)

(72) Inventors: Tanmay Aggarwal, Brentwood, CA (US); Rene Barakett, Brentwood, CA (US)

(21) Appl. No.: 18/813,794

(22) Filed: Aug. 23, 2024

Related U.S. Application Data
(60) Provisional application No. 63/535,497, filed on Aug. 30, 2023.
(60) Provisional application No. 63/535,501, filed on Aug. 30, 2023.

(51) Int. Cl. G06N 20/00

(52) U.S. Cl. CPC G06N 20/00

(57) ABSTRACT

One variation of a method includes: receiving a request for a machining strategy for machining a part defining a set of features at a machining facility; accessing a set of characteristics of a feature in the set of features; retrieving a strategy-generating model configured to output recommended machining strategies for machining features based on feature characteristics; deriving a set of recommended machining strategies for machining the feature based on the set of characteristics and the strategy-generating model, each machining strategy defining a sequence of operations and a set of operation parameters for each operation in the sequence of operations; for each machining strategy, deriving a rationale, in a set of rationale, for selection of the machining strategy based on a set of strategy metrics; and presenting the set of recommended machining strategies and the set of rationale, to a user associated with the machining facility.

### CROSS-REFERENCE TO RELATED APPLICATIONS

This Application claims the benefit of U.S. Provisional Application No. 63/535,497, filed on 30 Aug. 2023, and U.S. Provisional Application No. 63/535,501, filed on 30 Aug. 2023, each of which is incorporated in its entirety by this reference.

### TECHNICAL FIELD

This invention relates generally to the field of machining and more specifically to a new and useful method for selectively recommending machining strategies in the field of machining.

### BRIEF DESCRIPTION OF THE FIGURES

FIG. 1 is a flowchart representation of a first method;

FIG. 2 is a flowchart representation of one variation of the first method;

FIG. 3 is a flowchart representation of one variation of the first method;

FIG. 4 is a flowchart representation of one variation of the first method;

FIG. 5 is a flowchart representation of a second method;

FIG. 6 is a flowchart representation of one variation of the second method;

FIG. 7 is a flowchart representation of one variation of the second method; and

FIG. 8 is a flowchart representation of one variation of the second method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. First Method: Automated Strategy Recommendation

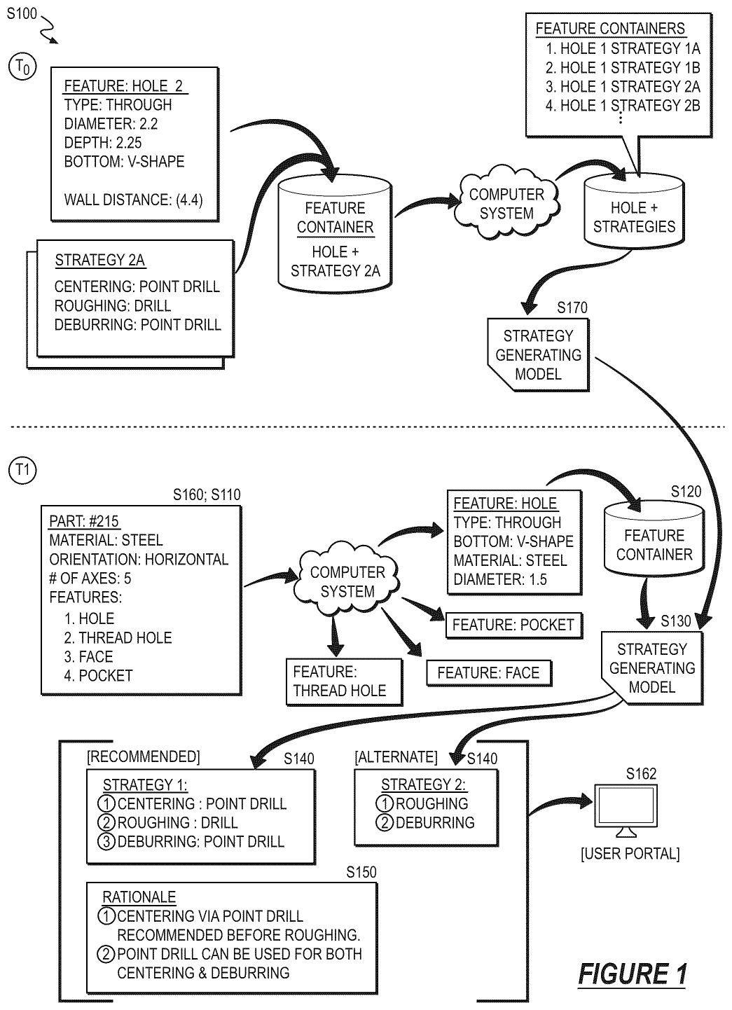

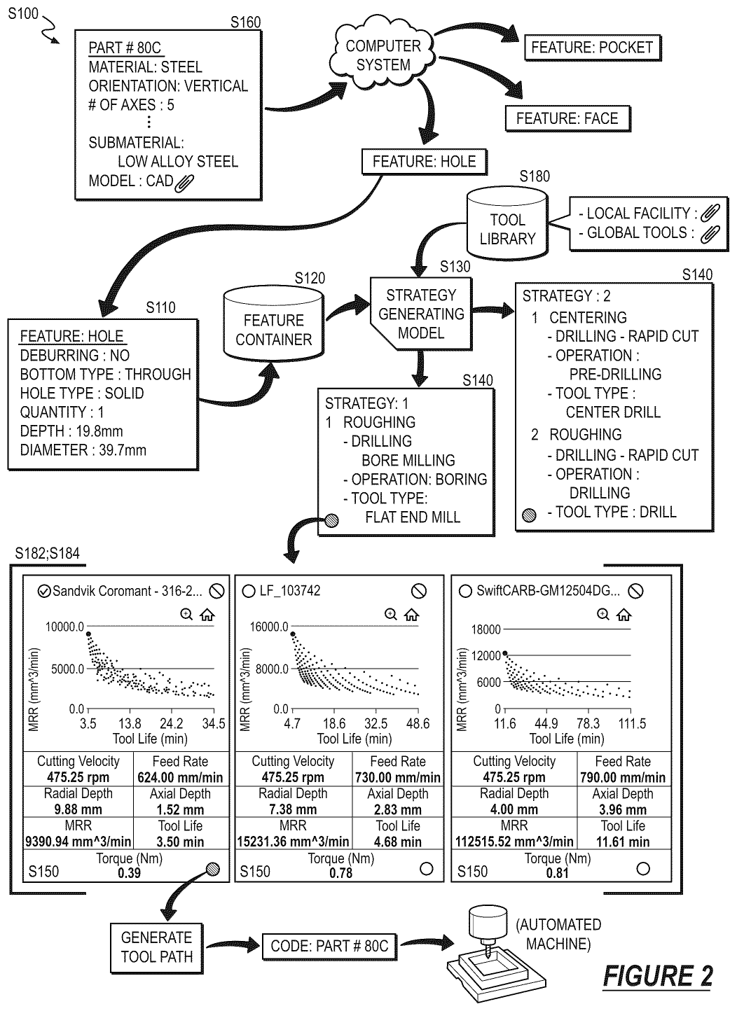

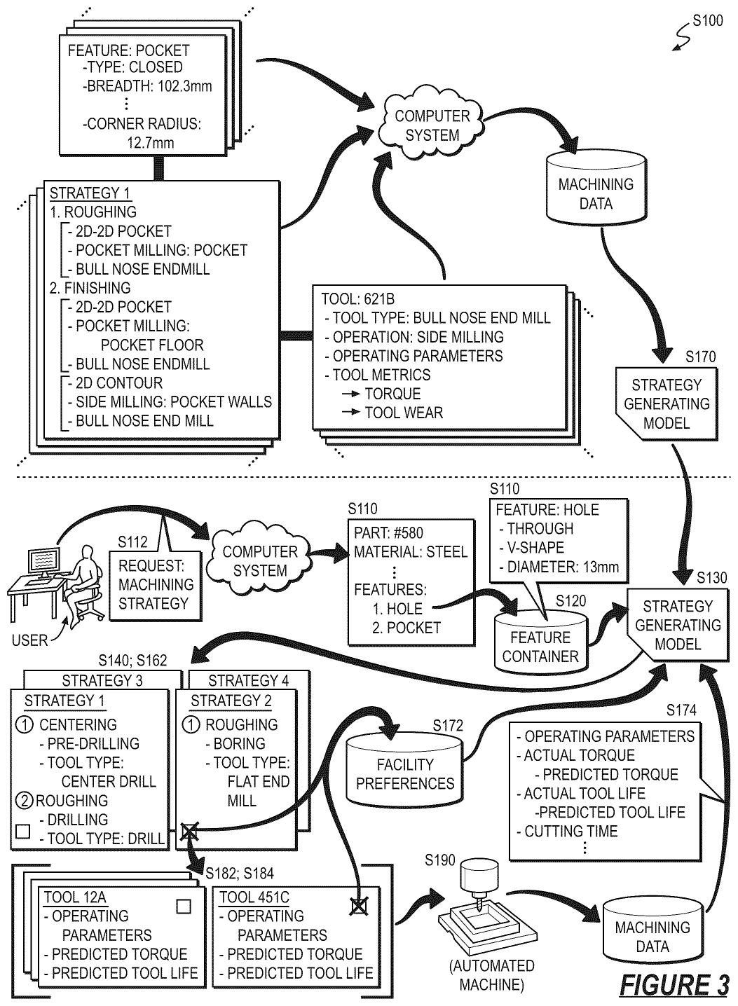

As shown in FIGS. 1-4, a method S100 includes, during an initial time period: accessing a corpus of machining data representing combinations of a set of features and machining strategies for machining the set of features; and training a strategy-generating model on the corpus of machining data to generate recommended machining strategies for machining a population of features based on characteristics of features in the population of features in Block S170. The method S100 further includes, during a first time period succeeding the initial time period: receiving a request for a machining strategy for machining a part defining a set of features in Block S160; for a first feature, in the set of features, accessing a first set of feature characteristics defined for the first feature in Block S110; and representing the first set of feature characteristics in a first feature container associated with the first feature in Block S120. The method S100 further includes, based on the first feature container and the strategy-generating model: generating a set of recommended machining strategies for machining the first feature in Block S140, each recommended machining strategy, in the set of recommended machining strategies, defining a sequence of machining operations implemented by an automated machine to machine the first feature, and, for each machining operation, in the sequence of machining operations, a set of operation parameters implemented by the automated machine during execution of the machining operation; and for each recommended machining strategy in the set of recommended machining strategies, generating a rationale, in a set of rationale, for selection of the machining strategy based on a set of strategy metrics in Block S150. The method S100 further includes serving the set of recommended machining strategies, paired with the set of rationale, to a user associated with the request in Block S162.

In one variation, the method S100 further includes, in response to selection of a first recommended machining strategy, in the set of recommended machining strategies, by the user: storing the first recommended machining strategy in a set of selected machining strategies selected by the user for machining the set of features of the part; generating a set of code defining instructions for executing the set of selected machining strategies to machine the part on an automated machine installed in a machining facility affiliated with the user; and triggering the automated machine to execute the set of code to machine the part according to the set of selected machining strategies in Block S190.

One variation of the method S100 includes: receiving a request for a machining strategy for machining a part defining a set of features from a user associated with a machining facility in Block S160; for a first feature, in the set of features, accessing a first set of feature characteristics defined for the first feature in Block S110; accessing a facility profile, in a population of facility profiles, associated with the machining facility and defining a suite of cutting tools available for machining parts at the machining facility in Block S180; and retrieving a strategy-generating model configured to output recommended machining strategies for machining a population of features based on characteristics of features in the population of features in Block S120. The method S100 further includes, based on the first set of feature characteristics, the suite of cutting tools, and the strategy-generating model: deriving a set of recommended machining strategies for machining the first feature, each recommended machining strategy, in the set of recommended machining strategies, defining a sequence of operations and a set of operation parameters for each operation in the sequence of operations in Block S140; and, for each recommended machining strategy in the set of recommended machining strategies, deriving a rationale, in a set of rationale, for selection of the machining strategy based on a set of strategy metrics in Block S150. The method S100 further includes serving the set of recommended machining strategies, paired with the set of rationale, to the user in Block S162.

As shown in FIG. 1, one variation of the method S100 includes: receiving a request for a machining strategy for machining a part defining a set of features; for a first feature, in the set of features, accessing a first set of feature characteristics (e.g., size, shape, material, type) defined for the first feature in Block S110; representing the first set of feature characteristics in a first feature container (e.g., represented as a vector or matrix) for the first feature in Block S120; retrieving a strategy-generating model configured to output recommended machining strategies for machining a population of features based on characteristics of features in the population of features in Block S130; deriving a set of recommended machining strategies—each machining strategy defining a sequence of operations and a set of operation parameters (e.g., a tool, a feed rate, a spindle speed, a depth of cut) for each operation in the sequence of operations—for machining the first feature of the part based on the first feature container and the strategy-generating model in Block S140; for each machining strategy in the set of recommended machining strategies, deriving a rationale, in a set of rationale, for selection of the machining strategy based on a set of strategy metrics (e.g., cut time, tool swap time, tool wear, machine wear, feature quality) in Block S150; and presenting the set of recommended machining strategies paired with the set of rationale to the user (e.g., within a native application).

### 1.1 First Method: Recommended Machining Strategy+Tool Selection

As shown in FIGS. 1-4, one variation of the method S100 includes: receiving a request for a machining strategy for machining a part defining a set of features via a user portal accessed by a user associated with a machining facility in Block S112; accessing a first set of feature characteristics defined for a first feature in the set of features in Block S110; and retrieving a strategy-generating model configured to output recommended machining strategies for machining a population of features based on characteristics of features in the population of features in Block S130; based on the first set of feature characteristics and the strategy-generating model, generating a set of recommended machining strategies for machining the first feature in Block S140, each recommended machining strategy, in the set of recommended machining strategies, defining a sequence of machining operations, and, for each machining operation, in the sequence of machining operations, a tool type for executing the operation; and serving the set of recommended machining strategies to the user via the user portal in Block S162.

In this variation, the method S100 further includes accessing a suite of tools accessible for execution of machining operations at the machining facility in Block S180. The method S100 further includes, in response to selection of a first recommended machining strategy, in the set of recommended machining strategies, by the user via the user portal, the first recommended machining strategy defining a first sequence of machining operations, for a first machining operation, in the first sequence of machining operations, defined for the first recommended machining strategy: accessing a first tool type defined for the first machining operation; based on the suite of tools and the first tool type, selecting a first subset of tools, in the suite of tools, of the first tool type and predicted to achieve a set of target metrics during execution of the first machining operation at the automated machine in Block S182; and serving the first subset of tools to the user via the user portal in Block S184.

### 2. Second Method: Automated Control of Machining Parameters

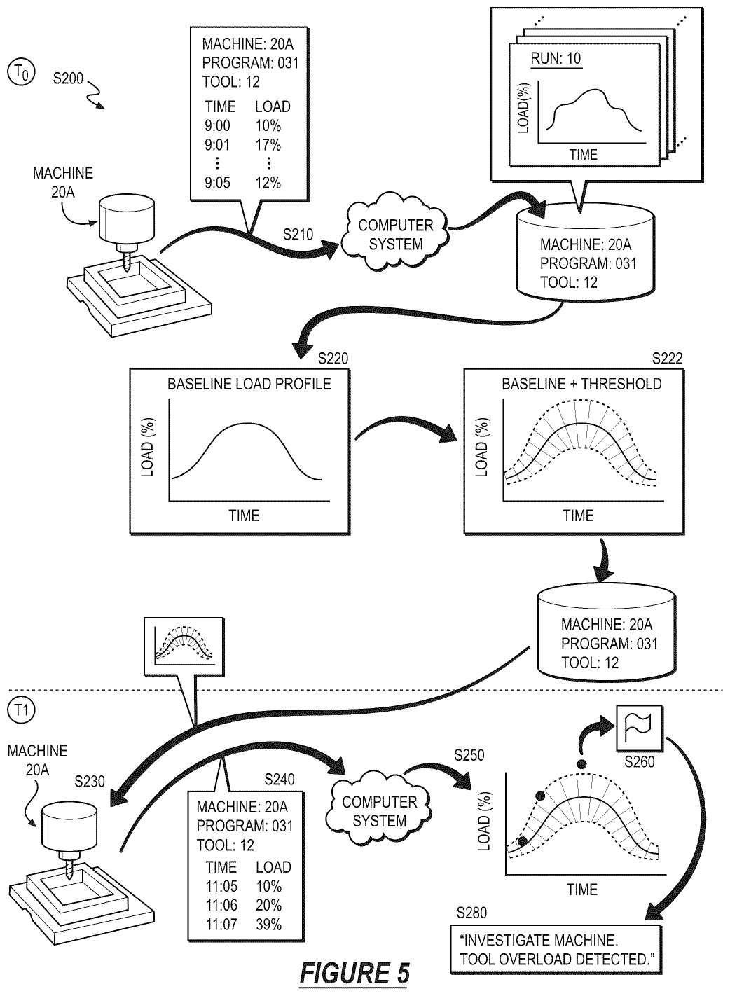

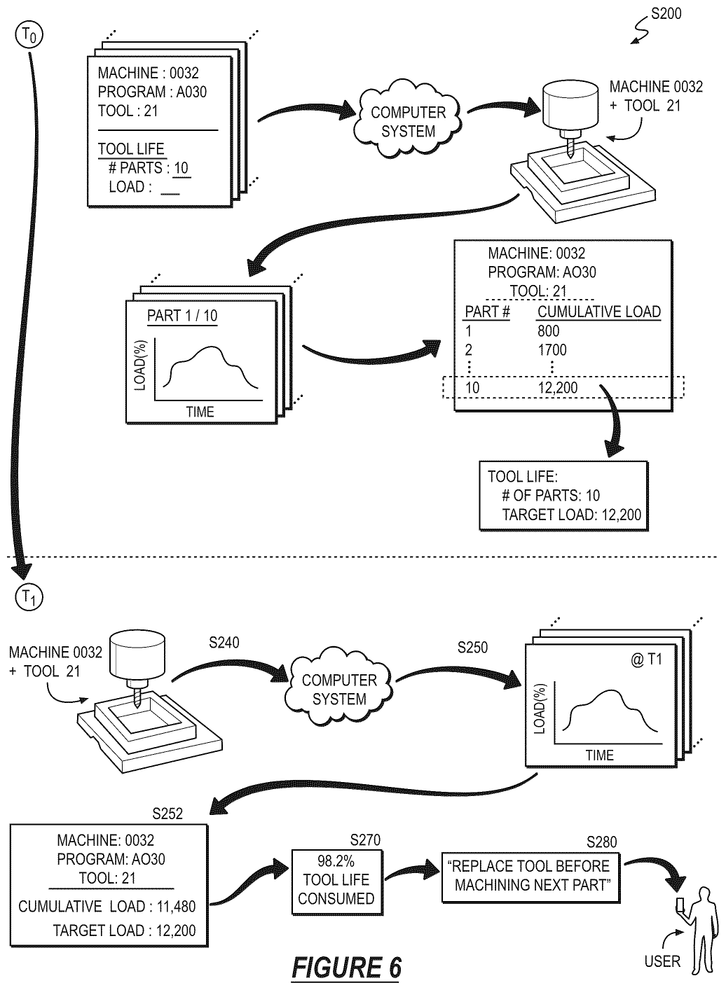

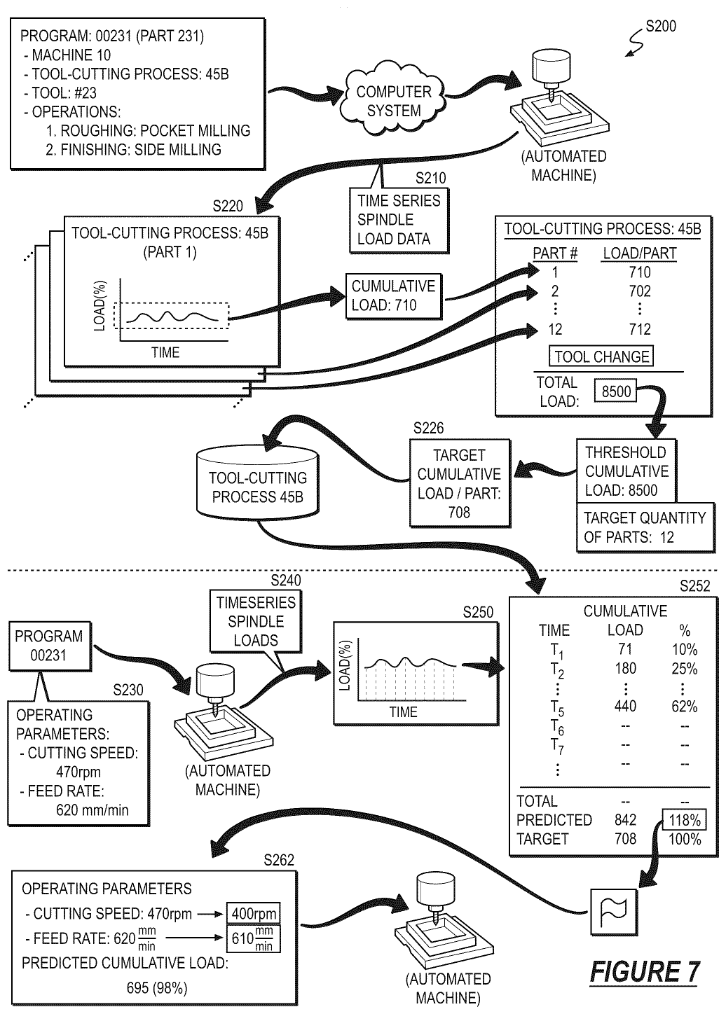

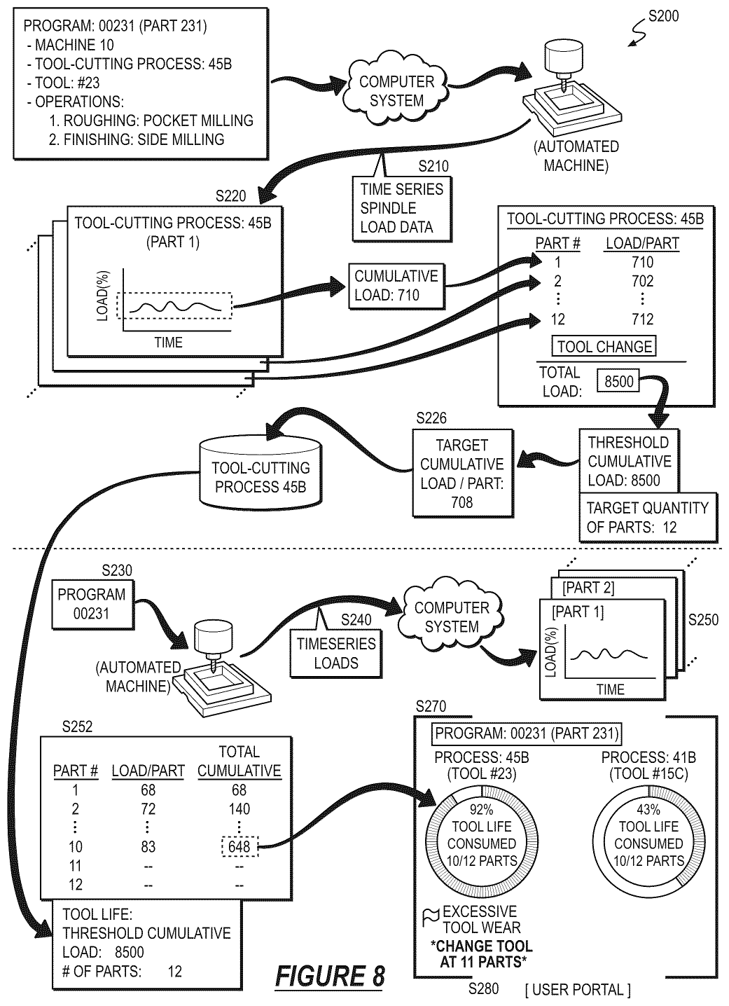

As shown in FIGS. 5-8, a method S200 includes: accessing a baseline load profile defined for execution of a first tool-cutting process, in a set of tool-cutting processes of a machining program defined for machining units of a first part at an automated machine, the first tool-cutting process corresponding to a sequence of operations executed via implementation of a first cutting tool, in a set of cutting tools, during machining of a unit of the first part in Block S220; and defining a target cumulative tool load experienced by the first cutting tool during execution of an instance of the first tool-cutting process based on the baseline load profile in Block S226.

The method S200 further includes, during execution of a first instance of the first tool-cutting process corresponding to machining of a first unit of the first part: at a first time, triggering the automated machine to execute the first instance of the first tool-cutting process according to a first set of operating parameters including a first feed rate and a first cutting speed of the first cutting tool in Block S230; accessing a first timeseries of load data output by a set of sensors integrated into the automated machine in Block S240; generating a first load profile for the tool-cutting process based on the first timeseries of load data, the first load profile representing change in loads experienced by a first instance of the first cutting tool implemented during execution of the first tool-cutting process in Block S250; tracking a cumulative tool load (e.g., in real time) experienced by the first instance of the first cutting tool based on the first load profile in Block S252; and characterizing a difference between the cumulative tool load experienced by the first instance of the first cutting tool and the target cumulative tool load. The method S100 further includes, based on the difference: selecting a second set of operating parameters for the first tool-cutting process, the second set of operating parameters including a second feed rate and a second cutting speed of the first cutting tool; and, at a second time succeeding the first time, triggering the automated machine to execute the first tool-cutting process via the first instance of the first cutting tool according to the second set of operating parameters in replacement of the first set of operating parameters in Block S262.

In one variation, the method S200 further includes: accessing an initial timeseries of load data captured by the automated machine executing the first tool-cutting process in Block S210. In this variation, Block S220 of the method S200 recites: based on the initial timeseries of load data, deriving a baseline tool load profile representing change in tool load experienced by the first cutting tool throughout execution of the first tool-cutting process.

### 2.1 Second Method: Real-Time Tool Life Tracking

As shown in FIGS. 5-8, one variation of the method S200 includes: accessing a baseline load profile defined for execution of a first tool-cutting process, in a set of tool-cutting processes of a machining program defined for machining units of a first part at an automated machine, the first tool-cutting process corresponding to operations executed via implementation of a first cutting tool, in a set of cutting tools, during machining of a unit of the first part in Block S220. The method S200 further includes, during execution of a first instance of the first tool-cutting process corresponding to machining of a first unit of the first part: accessing a first timeseries of load data output by a set of sensors integrated into the automated machine in Block S240; generating a first load profile for the first tool-cutting process based on the first timeseries of load data, the first load profile representing change in loads experienced by a first instance of the first cutting tool implemented during execution of the first instance of the first tool-cutting process in Block S250; deriving a cumulative tool load experienced by the first instance of the first cutting tool based on the first load profile in Block S252; accessing a threshold cumulative tool load defined for the first cutting tool and corresponding to a maximum tool life of the first cutting tool; and characterizing a difference between the cumulative tool load experienced by the first instance of the first cutting tool and the threshold cumulative tool load defined for the first cutting tool. In this variation, the method S200 further includes, based on the difference: characterizing a remaining tool life of the first instance of the first cutting tool in Block S270; and serving the remaining tool life to a user associated with the automated machine via an instance of a user portal executing on a computing device accessed by the user.

### 2.2 Second Method: Baselining+Real-Time Risk Detection

As shown in FIGS. 5-8, one variation of the second method S200 includes, during an initial time period: accessing an initial timeseries of load data captured by an automated machine executing a first tool-cutting process in a set of tool-cutting processes of a machining program defined for machining a particular part, the first tool-cutting process corresponding to a first cutting tool in a set of cutting tools implemented during execution of the machining program in Block S210; based on the initial timeseries of load data, deriving a baseline tool load profile representing change in tool load experienced by the first cutting tool throughout execution of the first tool-cutting process in Block S220; accessing a target deviation defined for the tool-cutting process; defining an upper baseline tool load profile based on the baseline tool load profile, the upper baseline tool load profile defining tool loads exceeding tool loads defined by the baseline tool load profile in Block S222; and defining a lower baseline tool load profile based on the baseline tool load profile and the target deviation, the lower baseline tool load profile defining tool loads falling below tool loads defined by the baseline tool load profile in Block S222.

In this variation, the method S200 further includes, during a first time period succeeding the initial time period and during execution of the tool-cutting process at the automated machine: triggering the automated machine to regulate tool load experienced by the first cutting tool according to the upper baseline tool load profile and the lower baseline tool load profile in Block S230; accessing a first timeseries of tool load data representing tool load experienced by a first instance of the first cutting tool during execution of the tool-cutting process in Block S240; and deriving a tool load profile for the tool-cutting process based on the first timeseries of tool load data in Block S250. The method S200 further includes, in response to the tool load profile defining a tool load falling outside the upper baseline tool load profile and the lower baseline tool load profile at a first time: interpreting a first risk event at the automated machine at the first time in Block S260; selecting a first action, in a set of actions, configured to mitigate the first risk event; triggering the automated machine to implement the first action in Block S262; and generating a first notification—indicating occurrence of the first risk event and the first tool load—and transmitting the first notification to a user associated with the automated machine in Block S280.

As shown in FIGS. 5-8, one variation of the method S200 includes, during an initial time period: accessing an initial timeseries of load data captured by an automated machine executing a first tool-cutting process—corresponding to a first cutting tool—in a set of tool-cutting processes of a machining program defined for machining a particular part in Block S210; deriving a baseline tool load profile—representing change in tool load experienced by the first cutting tool throughout execution of the first tool-cutting process—based on the initial timeseries of tool load data in Block S220; accessing a target deviation defined for the tool-cutting process; deriving an upper baseline tool load profile—defining tool loads exceeding tool loads defined by the baseline tool load profile—based on the baseline tool load profile and the target deviation in Block S222; deriving a lower baseline tool load profile—defining tool loads falling below tool loads defined by the baseline tool load profile—based on the baseline tool load profile and the target deviation in Block S222; and triggering the automated machine to regulate tool load experienced by the first cutting tool according to the upper baseline tool load profile and the lower baseline tool load profile in Block S230.

In this variation, the method S100 further includes, during a first time period succeeding the initial time period and during execution of the tool-cutting process at the automated machine: accessing a first time series of tool load data representing tool load experienced by a first instance of the first cutting tool during execution of the tool-cutting process in Block S240; and deriving a tool load profile for the tool-cutting process based on the first time series of tool load data in Block S250. The method S100 further includes, in response to the tool load profile depicting a tool load at a first time exceeding an upper tool load defined by the upper tool load profile at the first time: flagging the tool load at the first time as an instance of a risk event in Block S260; and generating a first notification—indicating detection of the risk event—and transmitting the first notification to a user affiliated with the automated machine in Block S280.

In one variation, the method S200 further includes: accessing a threshold cumulative tool load defined for the first cutting tool and corresponding to a maximum tool life of the first cutting tool; calculating a cumulative tool load for the first instance of the first cutting tool based on the tool load profile in Block S252; and characterizing a remaining tool life of the first instance of the first cutting tool based on a difference between the cumulative tool load and the threshold cumulative tool load in Block S270. In this variation, the method S200 further includes, in response to the remaining tool life falling below a threshold tool life: generating a second notification—indicating the remaining tool life of the first instance of the first cutting tool and including a prompt to install a second instance of the first cutting tool in replacement of the first instance of the first cutting tool—and transmitting the second notification to the user in Block S280.

### 3. Applications: Recommended Machining Strategies

Generally, Blocks of the method S100 can be executed by a computer system (e.g., a remote computer system, a computer network, a remote server) in conjunction with an application (e.g., native or web application) to: receive a request—such as from a computing device accessed by a user and executing the application—for a set of machining strategies for machining a particular feature (e.g., a hole, a threaded hole, a blind hole, a through hole, a face, a pocket) of a part via a CNC machine (or “machine”); access a set of characteristics defined for this particular feature, such as including a material, a size, a shape, a dimensional tolerance, an orientation, etc.; retrieve a strategy-generating model (e.g., a neural network) configured to ingest characteristics of features and automatically return corresponding machining strategies for machining these features; feed the set of feature characteristics into the strategy-generating model to derive a set of machining strategies for machining this particular feature (e.g., from a workpiece) according to the set of feature characteristics; and serve the set of machining strategies to the user for review and/or selection of a particular machining strategy.

For example, the computer system can return a recommended machining strategy defining: a sequence of operations (e.g., hole cutting, pocketing, face milling, side milling, deburring, centering, chamfering, filleting) executed via a CNC machine to produce the feature from a workpiece; a set of tools (e.g., a drill, a point drill, a face mill, a thread mill) required for execution of each operation in the sequence of operations; and/or a set of operation parameters for each operation in the sequence of operations, such as including a feed rate, a spindle speed, a depth of cut, etc.

Furthermore, the computer system can pair each suggested machining strategy with a rationale for selecting the suggested machining strategy. For example, the computer system can pair a suggested machining strategy with a rationale associated with: a duration of required machining time; a quantity of required tool changes; an amount of wear experienced by a corresponding tool or machine; a quality of the feature and/or resulting part; etc. The user may therefore review each suggested machining strategy—and the corresponding rationale paired with the machining strategy—and select a particular machining strategy best matched to the user's preferences and/or current needs.

In one implementation, the computer system: aggregates a population of feature containers, each feature container associated with a particular feature paired with a particular machining strategy for machining this particular feature and containing data representative of characteristics of this particular feature (e.g., material, size, type) and/or characteristics of the particular machining strategy (e.g., a sequence of operations, operation parameters, tool types); implements artificial intelligence, machine learning, regression, deep learning, and/or other techniques to train a neural network—or any alternative machine learning and/or deep learning model (e.g., decision tree, basin hopping)—to output recommended machining strategies for features of varying characteristics based on the set of feature containers; and stores this neural network (or other model type) as a strategy-generating model. Then, in response to receiving a request for a recommended machining strategy for a particular feature—defining a set of feature characteristics—the computer system can: initialize a feature container—such as represented in a vector of length equal to a total quantity of feature characteristics in the set of feature characteristics—for this feature; represent each feature characteristic, in the set of feature characteristics, in a corresponding slot in the feature container; and feed this feature container into the strategy-generating model to derive a set of recommended machining strategies for machining this feature according to the set of feature characteristics.

The computer system can then: pair each recommended machining strategy, in the set of recommended machining strategies, with a rationale—such as including a set of strategy metrics (e.g., a total machining time, a material-cutting time, an air-cutting time, a quality score, a predicted tool and/or machine wear, a quantity of tools required, a quantity of tool changes) corresponding to the recommended machining strategy; and present the set of recommended machining strategies—each machining strategy paired with the corresponding rationale—to the user within an instance of a user portal (e.g., a native application) executing on the user's computing device, such as in (near) real-time in response to receiving the request.

Furthermore, the computer system can update (or “retrain”) the strategy-generating model over time to output recommended machining strategies and/or corresponding rationale tailored to a particular machining facility, such as based on: historical machining data collected for this particular machining facility; selections and/or rejections of recommended machining strategies—output by the strategy-generating model—entered by a user(s) affiliated with the particular machining facility; and machining data (e.g., spindle load data and/or tool load data) captured at automated machines (e.g., configured to machine parts according to selected machining strategies)—and/or other metrics (e.g., tool life, cutting time, air time) derived from this machining data—responsive to implementation of recommended machining strategies at these automated machines. The computer system can therefore fine-tune the strategy-generating model for this particular machining facility in order to recommend machining strategies—paired with corresponding rationale supporting these machining strategies—better matched with machining preferences of the machining facility and actual outputs of automated machines at this machining facility.

### 3.1 Applications: Real-Time Process & Tool Life Monitoring

Generally, Blocks of the method S200 can be executed by the computer system in conjunction with the application to: characterize performance of a particular machine (e.g., a CNC machine), program for machining a part, and/or cutting tool based on time series machining data captured during execution of tool-cutting processes at the particular machine; selectively regulate operating parameters employed by the automated machine—such as globally and/or during execution of a particular program and/or tool-cutting process—based on performance and historical time series machining data; interpret changes in performance over time—such as based on changes in cutting times (e.g., material-cutting time, air-cutting time), part quality, tool utilization and/or tool life, etc.—responsive to modification of these operating parameters; and selectively generate and distribute notifications and/or prompts related to mitigating risks—associated with part quality, material waste or loss, decreased throughput in part machining, etc.—and/or improving performance of the automated machine, program, or cutting tool affiliated with a particular tool-cutting process.

In particular, in one implementation, the computer system can leverage baseline (or “initial”) time series load data—output by the automated machine and representing tool loads experienced by a cutting tool during execution of a tool-cutting process employing this particular cutting tool—to derive a baseline load profile (or “baseline load curve”) representing change in load experienced by the cutting tool throughout the tool-cutting process. The computer system can then derive a dynamic “upper” load profile and a dynamic “lower” load profile—such as falling within a fixed deviation of the baseline load profile—defining variable upper and lower bounds for tool load at various time points throughout the tool-cutting process. The computer system can repeat this process over several iterations (e.g., 5, 50, 100, 1000 iterations) of the tool-cutting process to derive a robust baseline load profile—and corresponding upper and lower load profiles—for this particular tool-cutting process.

The computer system can then leverage these baseline, upper, and lower load profiles to derive insights related to execution of the tool-cutting process based on a current load profile derived for the tool-cutting process, such as in (near) real-time during execution of the tool-cutting process. For example, the computer system can: retrieve time series load data output by the automated machine during execution of the tool-cutting process for machining a first unit of a part; derive a current tool load profile for the cutting tool based on this timeseries load data; and selectively flag deviations in the current tool load profile from the baseline tool load profile—which may correlate to errors or instances of increased risk—for investigation. In particular, the computer system can: flag instances of risk events—such as corresponding to a tool load exceeding an upper tool load defined by the upper tool load profile and/or falling below a lower tool load defined by the lower tool load profile—detected during execution of the tool-cutting process; and prompt the user to investigate the instance of the risk event; and/or selectively suggest an action and/or automatically execute an action—such as triggering the automated machine to pause execution of the tool-cutting process, automatically updating a set of operating parameters (e.g., a feed rate, a cutting speed) implemented by the automated machine, etc.—configured to mitigate the risk event and/or further minimize risk associated with the risk event.

Furthermore, the computer system can leverage timeseries load data captured for a particular tool-cutting process (e.g., corresponding to a particular cutting tool) to monitor tool life of the cutting tool and selectively prompt the user to replace the cutting tool. In particular, the computer system can correlate a cumulative tool load—experienced by the cutting tool across one or more iterations of the tool-cutting process—to a proportion of a tool life employed by the cutting tool. The computer system can then selectively prompt the user to replace the cutting tool—such as prior to breakage of the cutting tool and/or part damage due to overuse of the cutting tool—in response to the cumulative tool load experienced by the cutting tool meeting and/or falling within a threshold of a threshold cumulative tool load (e.g., a maximum cumulative tool load) associated with a maximum tool life of the cutting tool. For example, the computer system can: define a threshold cumulative tool load (e.g., a maximum tool load)—representing a maximum cumulative tool load experienced by a cutting tool across execution of one or more iterations of the tool-cutting process—associated with a maximum tool life of the cutting tool. Then, during execution of the tool-cutting process, the computer system can: access time series load data captured for the cutting tool during execution of the tool-cutting process; track a cumulative tool load experienced by the cutting tool based on the timeseries load data, such as in (near) real time; and, based on the cumulative tool load and the threshold cumulative tool load, predict a remaining tool life—such as represented by a quantity of units of a part machined via execution of tool-cutting process—of the cutting tool.

Therefore, rather than define a static, maximum tool life for the cutting tool—after which the user may discard and/or replace the cutting tool with a new cutting tool—the computer system can define a dynamic tool life for the cutting tool based on the amount of work (or “tool load”) experienced by the cutting tool. The computer system can therefore enable the user to replace the cutting tool with a new cutting tool prior to breakage of the cutting tool and/or decrease in tool functionality (e.g., below a threshold), thereby minimizing risk associated with reduction in part quality, machining errors, and/or material waste due to re-machining of parts. Furthermore, the computer system can enable the user to withhold replacement of the cutting tool prior to the cumulative tool load experienced by the cutting tool falling within a threshold difference of the threshold cumulative tool load, thereby reducing tool waste and costs associated with cutting tool replacement and/or increasing through-put by limiting time spent replacing and/or changing cutting tools.

### 4. Terms

Generally, “machine” refers to a CNC machine configured to process a block of material (or a “workpiece”) according to a set of programmable instructions.

Generally, “program” refers to instructions for machining a part from a workpiece via a set of cutting tools transiently or semi-permanently installed on an automated machine. For example, a program can define a sequence of operations (e.g. hole cutting, face milling, side milling, roughing, deburring) for machining a part via a set of cutting tools (e.g., a drill, a milling tool, a reamer) transiently or semi-permanently installed on an automated machine.

Generally, “tool-cutting process” refers to a subset of operations—in a sequence of operations defined by a program for machining a particular part—executed by an automated machine via implementation of a particular cutting tool in a set of cutting tools implemented during execution of the program.

In one example, a program defines: a sequence of operations executed by an automated machine for machining a part; and a set of tools implemented by the automated machine during execution of the sequence of operations. In this example, the tool-cutting process defines: a particular tool in the set of tools implemented by the automated machine during execution of the sequence of operations; and a subset of operations, in the sequence of operations, executed by the automated machine via the particular tool. The computer system can therefore define a unique tool-cutting process, in a set of tool-cutting processes defined for a program for machining a part, for each tool, in the set of tools, implemented during execution of the program.

### 5. User Portal

Generally, the computer system can host or interface with a user portal (e.g., a native application or web application) executing on a computing device (e.g., a mobile device, a computer) accessed by a user affiliated with a machining facility to: receive requests for recommended machining strategies for machining various parts and/or features of parts at a machining facility; and selectively recommend machining strategies—for machining features of parts at the machining facility—to the user responsive to these requests.

For example, the computer system can: receive a request for a machining strategy for machining a feature of a part from a user affiliated with a machining facility via an instance of a user portal executing on a computing device accessed by the user; implement Blocks of the method S100 to automatically generate a set of recommended machining strategies for machining the feature and a corresponding set of rationale for each recommended machining strategy in the set of recommended machining strategies; and present the set of recommended machining strategies—each paired with the corresponding set of rationale—to the user via the instance of the user portal, such as within seconds of receipt of the request.

Furthermore, the computer system can host or interface with the user portal—executing on a computing device accessed by a user affiliated with the machining facility—to provide insights related to one or more tool-cutting processes and/or selectively notify the user of risks associated with these tool-cutting processes, such as in (near) real time during execution of a particular tool-cutting process by an automated machine (e.g., a CNC machine).

### 6. Strategy Request: Machined Part+Features

Block S160 of the method S100 recites: receiving a request for a machining strategy for machining a part defining a set of features.

Generally, the computer system can receive a request for a machining strategy for machining a particular part. In particular, the computer system can receive a request—specifying a particular part and a set of features integrated into this particular part—for a set of machining strategies for machining each feature, in the set of features, from a workpiece (e.g., a block of material) in order to generate this particular part.

In one implementation, in response to receiving the request, the computer system can retrieve a set of part characteristics defined for the particular part specified in the request, such as including the set of features (e.g., a hole, a pocket, a face) and corresponding feature characteristics, a shape and/or size of the workpiece, a shape and/or size of the particular part, a material and/or materials forming the particular part, an automated machine for implementing the machining strategy to generate the particular part, etc. For example, in response to receiving the request, the computer system can: retrieve a model (e.g., a digital representation) of a part defining a set of features (e.g., a hole, a thread hole, a face, a pocket); and retrieve a model (e.g., a digital representation) of a workpiece configured for machining to form the part and defining a set of workpiece characteristics, such as including a material—defining a set of material properties (e.g., hardness, toughness, elasticity, ductility, malleability, plasticity, brittleness)—a shape, a size, a set of dimensions, etc. The computer system then leverages the model of the part in combination with the model of the workpiece to selectively suggest a set of machining strategies for machining the part—including the set of features—from the workpiece via a particular machine.

### 6.1 Feature Identification

Block S110 of the method S100 recites: accessing a set of feature characteristics defined for a feature, in the set of features, of the part (e.g., specified in the request).

Generally, in response to receiving a request for a machining strategy for a particular part, the computer system can identify a set of features integrated into the particular part. Then, for each feature, in the set of features, the computer system can retrieve a set of characteristics (or “feature characteristics”)—such as including a material, a dimension or size, a type, a dimensional tolerance, an orientation, a position, etc.—defined for the feature.

In one implementation, the computer system can prompt the user to manually label each feature, in the set of features, integrated into the particular part. Furthermore, the computer system can then prompt the user to manually enter and/or confirm a set of characteristics corresponding to each labeled feature.

In another implementation, the computer system can identify the set of features—and corresponding characteristics—based on a CAD model of the particular part. For example, to initiate the request, the user may upload a CAD model specifying a set of features—and a set of characteristics corresponding to each feature in the set of features—for a particular part. The computer system can then: receive this CAD model with the request; and automatically read the set of features—and the set of characteristics defined for each feature in the set of features—from the CAD model. Additionally or alternatively, in this implementation, the computer system can prompt the user to manually confirm and/or modify the set of features and corresponding characteristics.

Alternatively, in yet another implementation, the computer system can automatically extract a set of features from a part model (e.g., a 3D digital representation) of the particular part.

In particular, in this implementation, the computer system can: access a 3-dimensional representation of the part, such as included in the request submitted by the user; automatically identify a set of features represented in the 3-dimensional representation (e.g., via computer vision techniques and/or any alternative geometric modeling techniques); and, for each feature, in the set of features, extract a set of feature characteristics based on data extracted from the 3-dimensional representation. For example, the computer system can: automatically extract a first set of feature characteristics (e.g., a dimension, a size, a depth, a feature type) of a first feature in a set of features identified in a 3-dimensional representation of a part; and automatically extract a second set of feature characteristics of a second feature in the set of features identified in the 3-dimensional representation.

For example, in response to receiving a request for a machining strategy for a particular part, the computer system can: retrieve a part model—such as manually uploaded by a user—defined for the particular part and depicting the final, machined part and the corresponding set of features; and implement computer vision techniques—and/or any alternative geometric modeling techniques—to automatically extract and identify each feature in the set of features. In particular, in one example, the computer system can implement computer vision techniques to: identify a first feature—corresponding to absence of material—of a part; and label the first feature as a hole (e.g., a through hole, a blind hole, a threaded hole) based on characteristics of the first feature represented in the part model. The computer system can repeat this process for each feature, in the set of features, to derive a comprehensive list of features integrated into the particular part. For example, the computer system can identify and label the set of features including a set of holes, a set of faces, a set of pockets, a set of walls, a set of undercuts, etc.

### 6.2 Feature Container

In one implementation, Block S120 recites: representing the set of feature characteristics of the feature in a feature container associated with the feature.

In particular, in this implementation, in response to identifying a feature, in the set of features, of a part, the computer system can initialize a feature container (e.g., a vector) representative of this particular feature.

For example, the computer system can: receive a request for a machining strategy for machining a part from a workpiece; access a CAD model defined for the part and depicting a set of features integrated into the part; extract a first feature, in the set of features, defining a first set of characteristics including a first material, a first type, a first size, and a first position of the first feature; initialize a first container for the first feature; and populate the first container with data representative of the first set of characteristics of the first feature.

In particular, in one example, the computer system can: identify a feature—corresponding to a thread hole—defined for a part; extract a set of characteristics of the thread hole, such as including a thread size, a thread depth, a drill depth, a hole type (e.g., blind), a hole-bottom type (e.g., V-shape), a thread pitch, a nearest wall distance in an “X” direction, a nearest wall distance in a “Y” direction, a drill diameter, a drill angle, presence or absence of deburring, and/or a countersink angle; and initialize a feature container representative of the thread hole for this particular part. In particular, the computer system can: initialize the feature container for the thread hole; and represent the set of characteristics within the feature container. For example, the computer system can: represent the thread size as a first value within a first slot in the feature container; represent the drill depth as a second value within a second slot in the feature container; represent the hole type as a third value within a third slot in the feature container; represent the hole-bottom type as a fourth value within a fourth slot in the feature container; represent the thread pitch as a fifth value within a fifth slot in the feature container; etc.

### 7. AI Modelling

Block S170 of the method S100 recites: accessing a corpus of machining data representing combinations of a set of features and machining strategies for machining the set of features; and training a strategy-generating model on the corpus of machining data to generate recommended machining strategies for machining a population of features based on characteristics of features in the population of features.

Generally, the computer system can implement artificial intelligence, machine learning, regression, deep learning, and/or other techniques to train a strategy-generating model to return a set of recommended machining strategies for machining a particular feature (e.g., a hole, a through hole, a blind hole, a face, a pocket) from a workpiece configured to form an machined part. In particular, the computer system can implement artificial intelligence, machine learning, regression, deep learning, and/or other techniques to train a strategy-generating model—such as a neural network, a decision tree, a basin-hopping model, a machine-learning model, or any other type of model—to return one or more recommended machining strategies for a feature based on specified characteristics of this feature. In one example, the computer system can implement adversarial and convolutional neural networks to train a strategy generator (i.e., the strategy-generating model) configured to: ingest a set of feature characteristics of a particular feature defined for an machined part; and return a set of recommended machining strategies for machining the feature from a workpiece configured to form the machined part.

In one implementation, the computer system can: access a first set of feature data representative of characteristics of a particular feature in a host of features; access a first set of strategy data representative of a sequence of machining operations defined by a particular machining strategy for machining the particular feature; represent the first set of feature data and the first set of strategy data in a first feature container—corresponding to the particular feature paired with the particular machining strategy—in a corpus of feature containers representing combinations of the host of features and machining strategies for machining the host of features; and train the strategy-generating model on the corpus of feature containers.

In particular, the computer system can initialize a feature container for each combination of feature and machining strategy and therefore populate each feature container, in the population of feature containers, with: a set of feature data representative of characteristics of a corresponding feature in the host of features; and a set of strategy data representative of a sequence of machining operations defined by a corresponding machining strategy for machining the corresponding feature.

For example, in this implementation, the computer system can: access a population of feature containers, each feature container, in the population of feature containers, containing data representative of a particular feature paired with a particular machining strategy; and leverage the population of feature containers to train the strategy-generating model to ingest a set of feature characteristics—defined for a particular feature of a part—and output a set of recommended machining strategies for machining this particular feature of the part accordingly.

In particular, in this example, the computer system can access a first feature container—corresponding to a first feature paired with a first machining strategy—containing: a first set of data representative of characteristics of the first feature; and a second set of data representative of a sequence of operations defined by the first machining strategy. The computer system can similarly access additional feature containers: corresponding to the first feature paired with alternative machining strategies; and/or corresponding to alternative features paired with various machining strategies defined for these alternative features. The computer system can therefore train the strategy-generating model to output one or more recommended machining strategies for a suite of features—defining varying feature characteristics—based on this population of feature containers.

### 7.1 AI Modelling: One Feature+One Machining Strategy

In one implementation, the computer system can access a feature container, in the population of feature containers, representing a single feature paired with a single machining strategy.

In this implementation, for a first feature, in a population of predefined features, the computer system can access a first feature container (e.g., a vector, a matrix)—defined for the first feature paired with a first machining strategy—such as containing: a first set of data representing a first set of characteristics of the first feature, such as including a material of a workpiece associated with the first feature, a type of the first feature, a size (e.g., dimension, depth, width, height, area), a shape, a dimensional tolerance, an orientation, a position, etc.; and a second set of data representing a first sequence of operations (e.g., centering, roughing, deburring, threading)—defining operation type(s), a set of operation parameters (e.g., feed rate, spindle speed, depth of cut) for each operation, a type(s) of the tool for each operation, etc.—defined for the first machining strategy.

For example, the computer system can access the first feature container containing the first set of data representing the first set of characteristics of the first feature and the second set of data representing: a type of each operation in the first sequence of operations, such as including centering, roughing, deburring, threading, etc.; a set of operation parameters defined for each operation in the sequence of operations, such as including a feed rate, a spindle speed, a depth of cut, etc.; and/or a first set of tools required for executing the first sequence of operations, each tool, in the set of tools, corresponding to a particular operation in the first sequence of operations.

In this implementation, the computer system can similarly access a second feature container—defined for the first feature machined via a second machining strategy—containing: the first set of data representing the first set of characteristics of the first feature; and a third set of data representing a second sequence of operations—defining operation type(s), a set of operation parameters (e.g., feed rate, spindle speed, depth of cut) for each operation, a type(s) of tool for each operation, etc.—defined for the second machining strategy.

The computer system can repeat this process to compile a first group of feature containers (e.g., represented as vectors or matrices) representative of the first feature—exhibiting varying characteristics—paired with different machining strategies. The computer system can then leverage this group of feature containers to train the strategy-generating model (e.g., via artificial intelligence, machine learning, regression) to return a set of recommended machining strategies for the first feature given a set of feature characteristics defined for the first feature. Furthermore, the computer system can repeat this process for each feature, in a population of features, to: compile a population of feature containers representative of features, in the population of features, paired with varying machining strategies defined for these features; and thereby train the strategy-generating model to return a set of recommended machining strategies for each feature, in the population of features, based on characteristics of this particular feature.

### 7.1.1 Example: Thread Hole

In one example, the computer system can access a first feature container—such as represented in a vector of length equal to a total quantity of predefined feature characteristics and strategy characteristics (e.g., operation types, operation parameters, tools)—defined for a first feature corresponding to a “thread hole” paired with a first machining strategy defining a first sequence of operations—including a first operation of “centering,” a second operation of “roughing,” and a third operation of “threading”—and a first set of operating parameters. In particular, in this example, the computer system can access the first feature container defined for the “thread hole” paired with the first machining strategy and containing a first set of values—assigned to a first set of positions within the vector—representing the feature characteristics of the thread hole, such as including: a first value—representing a material of a workpiece from which the thread hole is cut—assigned to a first position within the vector; a second value—representing a thread size of the thread hole—assigned to a second position within the vector; a third value—representing a thread depth of the thread hole—assigned to a third position within the vector; a fourth value—representing a circumference of the thread hole—assigned to a fourth position within the vector; etc.

In the preceding example, the first feature container can further contain a second set of values assigned to a second set of positions within the vector and representing the first sequence of operations of the first machining strategy, such as including: a first subset of values—representing the first operation—including a fifth value corresponding to “centering” and assigned to a fifth position within the vector, a sixth value corresponding to a point drill implemented during the “centering” operation and assigned to a sixth position within the vector, a seventh value corresponding to a feed rate of the point drill implemented during the “centering” operation, etc.; a second subset of values—representing the second operation of “roughing”—including an eighth value corresponding to “roughing” and assigned to an eighth position within the vector, a ninth value corresponding to a drill implemented during the “roughing” operation and assigned to a ninth position within the vector, etc.; and a third subset of values—representing the third operation of “threading”—including a tenth value corresponding to “threading” and assigned to a tenth position within the vector, an eleventh value corresponding to a thread mill implemented during the “threading” operation and assigned to an eleventh position within the vector, etc.

Furthermore, the computer system can compile additional feature containers—corresponding to the “thread hole” feature—representing the “thread hole” paired with varying machining strategies. In particular, in this example, the computer system can similarly access a second feature container defined for the “thread hole” paired with a second machining strategy defining the first sequence of operations and a second set of operating parameters distinct from the first set of operating parameters. In particular, in this example, the computer system can access the second feature container—defined for the “thread hole” paired with the second machining strategy—containing the first set of values representing feature characteristics of the thread hole and a third set of values representing the first sequence of operations and the second set of operating parameters of the second machining strategy, such as including: the first subset of values representing the first operation of “centering”; the second subset of values representing the second operation of “roughing”; and a fourth subset of values including the tenth value corresponding to “threading” and a twelfth value corresponding to a tap—distinct from the thread mill implemented during execution of the third operation of the first machining strategy—implemented during the “threading” operation.

Furthermore, the computer system can compile additional feature containers—corresponding to the “thread hole” feature—representing “thread holes” of varying feature characteristics paired with one or more machining strategies. In particular, in this example, the computer system can access a third feature container corresponding to a first “thread hole”—defining a first set of feature characteristics—paired with a first machining strategy, such as containing: a first value representing a first material of a workpiece from which the thread hole is cut; a second value representing a first thread size of the thread hole; a third value representing a first thread depth of the thread hole; and a first subset of values representing the first machining strategy. The computer system can similarly access a fourth feature container corresponding to a second “thread hole”—defining a second set of feature characteristics—paired with the first machining strategy, such as containing: a fourth value representing a second material of a workpiece from which the thread hole is cut; a fifth value representing a second thread size of the thread hole; a sixth value representing a second thread depth of the thread hole; and the first subset of values representing the first machining strategy.

The computer system can thus compile a group of feature containers—corresponding to the “thread hole” feature—representing “thread holes” of varying feature characteristics paired with machining strategies—defining varying operations, operation parameters, and/or tool types—for machining a “thread hole.”

The computer system can then leverage this group of feature containers to train a strategy-generating model (e.g., via artificial intelligence, machine learning, regression) to return a set of recommended machining strategies for machining a “thread hole” within an machined part given a set of feature characteristics defined for the “thread hole” within the machined part.

### 7.1.2 Combinations of Features

In one variation, the computer system can access a feature container, in the population of feature containers, representing a combination of features paired with a set of machining strategies for machining the combination of features (e.g., in a single session).

For example, the computer system can: access a first feature container defined for a first combination of features—such as including a first feature of a “face” and a second feature of a “pocket”—paired with a first machining strategy including a first operation of “face milling” defined for machining the “face” and a second operation of “end milling” defined for machining the “pocket”; and access a second feature container defined for the first combination of features paired with a second machining strategy including a first operation of “end milling” defined for machining the “face” and a second operation of “end milling” defined for machining the “pocket.”

### 7.1.3 Rationale

In one variation, the computer system can train the strategy-generating model to output a set of recommended machining strategies for machining a particular feature and a rationale(s)—such as one or more units of evidence supporting a recommended machining strategy—for recommending each of these machining strategies. In this variation, to train the strategy-generating model, the computer system can access a first feature container defined for a first feature paired with a first machining strategy—defining a sequence of operations and a rationale associated with the first machining strategy—such as containing: a first set of data representing a set of characteristics defined for the first feature; a second set of data representing the sequence of operations (e.g., centering, roughing, deburring, threading) defined for the first machining strategy; and a third set of data representing the rationale defined for the first machining strategy. In particular, the computer system can: compile a population of feature containers—including the first feature container—each feature container containing data associated with a corresponding feature, a corresponding machining strategy, and/or a corresponding rationale supporting the machining strategy; and, based on the set of feature containers, train the strategy-generating model to output one or more recommended machining strategies—paired with one or more rationale—given a set of characteristics of a feature.

### 8. Selecting Machining Strategies

Block S140 of the method S100 recites: based on the first feature container and the strategy-generating model, generating a set of recommended machining strategies for machining the first feature, each recommended machining strategy, in the set of recommended machining strategies, defining a sequence of machining operations—implemented by an automated machine to machine the feature—and, for each machining operation, in the sequence of machining operations, a set of operation parameters (e.g., feed rate, spindle speed, tool type) implemented by the automated machine during execution of the machining operation.

The computer system can leverage the strategy-generating model to selectively suggest a set of recommended machining strategies for machining a particular feature of a part according to a set of feature characteristics defined for this particular feature (e.g., by a CAD model, by a 3D representation, by a user).

In one implementation, the computer system can: receive a request for a machining strategy for machining a part from a workpiece; and access a CAD model defined for the part and depicting a set of features integrated into the part. The computer system can then: extract a first feature, in the set of features, defining a first set of characteristics, such as including a first material, a first type, a first set of dimensions, a first size, and a first position of the first feature; initialize a first container for the first feature; populate the first container with data representative of the first set of characteristics of the first feature; and feed this first container into the strategy-generating model to generate a set of recommended machining strategies for machining the first feature of the part.

The computer system can similarly repeat this process for each feature, in the set of features, to generate a set of recommended machining strategies for each feature in the set of features. The user may therefore select a particular machining strategy, from the set of recommended machining strategies, for each feature to assemble a comprehensive machining strategy for machining the part.

For example, for a first feature of a part, the computer system can: access a first set of feature characteristics including a first feature type, a first feature material, and a first set of feature dimensions defined for the first feature; initialize a first feature container for the first feature; represent the first feature type in a first data slot in the first feature container; represent the first feature material in a second data slot in the first feature container; and represent the first set of dimensions in a third data slot in the first feature container. Then, based on the first feature container—representing the first set of feature characteristics of the first feature—and the strategy-generating model, the computer system can automatically generate a set of recommended machining strategies for machining the first feature.

In one example, the computer system can initialize a first container for a “thread hole” integrated within a part specified in the request and represent a first set of characteristics of the “thread hole”—such as including a thread size, a drill depth, a hole type, a thread pitch, etc.—within the first container. The computer system can then feed this first container into the strategy-generating model to generate a first set of recommended strategies for machining the “thread hole” within this particular part, such as including: a first machining strategy including a first operation of centering via a point drill, a second operation of roughing via a drill, and a third operation of threading via a thread mill; a second machining strategy including a first operation of centering via a point drill, a second operation of roughing via a drill, and a third operation of threading via a tapping tool; and a third machining strategy including a first operation of centering via a point drill, a second operation of roughing via a drill, and a third operation of threading via a forming tool.

Furthermore, the computer system can generate a recommended machining strategy defining a sequence of machining operations and, for each machining operation, in the sequence of machining operations, such as including an operation type, a tool type (e.g., drill, center drill, end mill), etc.

For example, the computer system can: access a first set of feature characteristics defined for a first feature corresponding to a first hole, the first set of feature characteristics including a hole type (e.g., a thread hole) and a set of hole dimensions (e.g., a hole depth, a hole diameter); and implement the strategy-generating model to generate a set of recommended machining strategies for machining the first hole based on the first set of feature characteristics.

In this example, the computer system can generate a first recommended machining strategy defining a first sequence of machining operations including: a first centering operation defining a first set of centering parameters including a first operation type of pre-drilling and a first tool type of center drill; and a first roughing operation defining a first set of roughing parameters including a second operation type of drilling and a second tool type of drill.

The computer system can also generate a second recommended machining strategy defining a second sequence of machining operations including: a second centering operation defining a second set of centering parameters including the first operation type of pre-drilling and the first tool type of center drill; a second roughing operation defining a second set of roughing parameters including the second operation type of drilling and the second tool type of drill; and a finishing operation defining a set of finishing parameters including a third operation type of bore milling and a third tool type of flat end mill.

In one variation, the computer system can leverage the strategy-generating model to selectively suggest a set of recommended machining strategies for machining a particular combination of features of a part. For example, the computer system can initialize a first container for a “face” and a “pocket” integrated within a part specified in the request and represent a first set of characteristics of the “face” and a second set of characteristics of the “pocket” within the first container. The computer system can then feed this first container into the strategy-generating model to generate a first set of recommended strategies for machining the “face” and the “pocket” within this particular part (e.g., during a single machining session), such as including: a first machining strategy including a first operation of face milling for machining the face and a second operation of end milling for machining the pocket; and a second machining strategy including a first operation of end milling for machining the face and a second operation of end milling for machining the pocket.

The computer system can suggest machining strategies—specifying types of tools implemented during execution of various operations—based on a tool library defined for the request. In one implementation, the computer system can implement a default tool library—such as including a variety of tools commonly implemented in machining applications—and selectively suggest machining strategies based on tools included in the default tool library. Alternatively, in another implementation, the computer system can prompt a user to manually upload a custom tool library available for implementation in recommended machining strategies suggested by the computer system. The computer system can then generate a tool library (e.g., a digital tool library) based on the tools manually entered and/or selected by the user.

### 8.1 Machining Strategy+Rationale

Block S150 of the method S100 recites: based on the first feature container and the strategy-generating model, for each recommended machining strategy, in the set of recommended machining strategies, deriving a rationale, in a set of rationale, for selection of the machining strategy based on a set of strategy metrics (e.g., time, tool life, machine life, feature quality).

Furthermore, Block S162 of the method S100 recites: serving the set of recommended machining strategies, paired with the set of rationale, to a user associated with the request.

Generally, the computer system can pair each recommended machining strategy with a rationale (or “support”) for selecting the recommended machining strategy.

In particular, the computer system can: access a set of feature characteristics of a feature integrated within a part; leverage the strategy-generating model to derive a set of recommended machining strategies for machining the feature within the part; and, for a first machining strategy in the set of recommended machining strategies, derive a first rationale—corresponding to one or more strategy metrics (e.g., time, tool life, machine life, feature quality)—that supports selection of the first recommended machining strategy for machining the feature. For example, the computer system can derive and present rationale associated with a set of strategy metrics, such as including time (e.g., total time for completing the feature, tool swap time, tool cut time, ratio of time cutting versus time in air), tool wear and/or tool life, machine wear and/or machine life, feature quality (e.g., accuracy, precision, repeatability, concentricity), etc. The computer system can therefore present this first rationale—in combination with the first recommended machining strategy—to the user for review (e.g., within the native application). The computer system can similarly repeat this process for each recommended machining strategy, in the set of recommended machining strategies, for presentation of the set of recommended machining strategies—in combination with a set of rationales—to the user.

In one example, the computer system can derive a set of rationale for pairing with a first machining strategy—including a centering operation implementing a point drill, a roughing operation implementing a drill, and a deburring operation implementing the point drill—for machining a thread hole, such as including: a first rationale specifying that a point drill is recommended for centering before implementing the drill for roughing; a second rationale specifying that implementation of a drill is recommended for thread holes of a particular shape (e.g., a V shape bottom); and a third rationale specifying that a point drill can be implemented for both the centering operation and the deburring operation.

In another example, in response to a request for a machining strategy for machining a pocket—exhibiting a particular set of characteristics—the computer system can return: a first machining strategy including a first operation of roughing and a second operation of finishing; a second machining strategy including a first operation of roughing, a second operation of finishing, and a third operation of cornering; and a third machining strategy including a first operation of roughing, a second operation of finishing, and a third operation of curling. Furthermore, the computer system can return a rationale specifying that: a roughing operation is required to remove excess material to form the pocket; and a finishing operation is required—following the roughing operation—to yield a target surface finish for the pocket.

In another example, the computer system can derive a set of rationale for pairing with a machining strategy for machining a combination of features. In particular, in this example, the computer system can derive: a first set of rationale for pairing with a first machining strategy for machining a face and a pocket—including a face milling operation and an end milling operation—specifying a relatively high quality face finish; and a second set of rationale for pairing with a second machining strategy for machining the face and the pocket—including an end milling operation for both the face and the pocket—specifying a relatively low spindle load and absence of a tool change.

In one implementation, the computer system can selectively present a set of recommended machining strategies paired with rationale matched to varying strategy metrics. For example, the computer system can: suggest a first machining strategy configured to minimize an amount of time required to machine a particular feature; a second machining strategy configured to minimize wear on a tool implemented during machining of the particular feature; and a third machining strategy configured to maximize quality of the particular feature.

### 8.1.1 Variation: Key Metrics

In one variation, the computer system can prompt the user to select one or more key metrics prior to selection of a set of recommended machining strategies for machining a particular feature of a part.

In particular, in this variation, in response to receiving a request for a recommended machining strategy for machining a set of features of a part, the computer system can prompt the user to select one or more key metrics—such as including machining time, tool time, air time, machine wear, tool wear, feature quality, etc.—for prioritizing in selection of recommended machining strategies for this set of features. For example, the computer system can render a slider tool configured to enable the user to select a target balance between time, wear, and quality. The computer system can then leverage this selected key metric or key metrics to filter a set of recommended machining strategies—derived for this set of features—to a subset of recommended machining strategies that best correspond to the selected key metric or key metrics selected by the user.

In one example, in response to receiving selection of a first key metric for a request for a machining strategy—specifying a particular part defining a set of features—submitted by the user, the computer system can: identify a first feature in the set of features; access a set of characteristics of the first feature; initialize a feature container for the first feature; represent the set of characteristics within a first set of positions or slots within the first container; and represent the first key metric in a particular position or slot configured to receive data associated with key metrics; and feed the feature container into the strategy-generating model to automatically return a set of recommended machining strategies for machining the first feature of this particular part according to the set of characteristics—defined for the first feature—and the first key metric selected by the user.

### 8.1.2 Variation: Manual Strategy Generation

In one variation, the computer system can enable the user to manually enter a machining strategy for a particular feature via the user portal.

In particular, in this variation, the computer system can: serve the user a set of recommended machining strategies for machining a feature responsive to receipt of a request from the user via the user portal; and, serve the user a manual strategy-generation option—such as a selectable feature within the user portal—configured to enable the user to manually select and/or enter a sequence of machining operations and corresponding operation parameters to generate a machining strategy for a particular feature. For example, rather than select a recommended machining strategy, from the set of recommended machining strategies, the user may select the manual-strategy generation option, such as a selectable icon labeled with a text string of “Add Strategy.” The computer system can then prompt the user to select and/or enter a sequence of machining operations and corresponding operation parameters—such as including an operation type, a tool type, etc.—to manually generate a machining strategy for machining the particular feature.

In one implementation, the computer system can prompt the user to manually enter a machining strategy for machining a particular feature responsive to rejection (e.g., by the user) of a set of recommended machining strategies provided for machining the particular feature.

For example, in this implementation, the computer system can: receive a request for recommended machining strategies for machining a set of features of a part; and implement Blocks of the method S100 to automatically generate and serve a set of recommended machining strategies—for machining a first feature in the set of features—to the user via the user portal. Then, in response to rejection of the set of recommended machining strategies by the user, the computer system can: generate a prompt to manually enter a new machining strategy for machining the first feature of the part; transmit the prompt to the user via the user portal; and, in response to receipt of the new machining strategy generated by the user, store the new machining strategy in a set of selected machining strategies selected by the user for machining the set of features of the part.

Additionally, in the preceding example, the computer system can update (or “retrain”) the strategy-generating model based on rejection of the set of recommended machining strategies, the new machining strategy entered by the user, and feature characteristics of the first feature.

Additionally or alternatively, in another implementation, the computer system can enable the user to modify the set of recommended machining strategies served to the user within the user portal. In particular, in this implementation, the computer system can: serve the user a set of recommended machining strategies for machining a feature of a part responsive to receipt of a request from the user via the user portal; and, for each recommended machining strategy, in the set of recommended machining strategies, serve the user a strategy-editing option—such as a selectable feature within the user portal—configured to enable the user to manually edit a sequence of machining operations and/or corresponding operation parameters specified in the recommended machining strategy output by the strategy-generating model. The computer system can then store an edited machining strategy—for machining the feature—in a set of selected machining strategies selected by the user for machining a set of features of the part.

Furthermore, in the preceding implementation, the computer system can similarly update (or “retrain”) the strategy-generating model based on manual changes entered by the user to the set of recommended machining strategies.

### 8.1.3 Variation: Default Strategy Selection

In one variation, the computer system can enable the user to automatically select a default machining strategy for machining a particular feature via the user portal. For example, rather than require the user to review multiple recommended machining strategies output by the strategy-generating model and select a particular recommended machining strategy, the computer system can: receive confirmation from the user (e.g., via the user portal) to implement a default machining strategy to machine a particular feature—and/or multiple and/or all features—of a part; implement the strategy-generating model to generate the default machining strategy—defining a sequence of machining operations, tool types, particular tools, etc.—based on feature characteristics of the particular feature and/or part; and automatically implement this default machining strategy, such as by automatically generating the corresponding tool paths.

### 8.2 Variation: Strategy+Tool Selection

In one variation, the computer system can prompt the user to select a particular cutting tool—from a set of cutting tools of a particular tool type—for execution of a selected recommended machining strategy defining the particular tool type.

In particular, in this variation, the computer system can implement the methods and techniques described above to generate and suggest a set of recommended machining strategies for machining a particular feature of a part. Then, in response to selection (e.g., by the user) of a first recommended machining strategy—defining a sequence of machining operations—in the set of recommended machining strategies, the computer system can selectively present the user (e.g., via the user portal) with a set of cutting tools for implementing each machining operation in the sequence of machining operations based on tool types defined by each of these machining operations.

For example, the user may select a recommended machining strategy defining a first machining operation specifying a tool type of a flat end mill. In response to receipt of selection of this recommended machining strategy, the computer system can present the user with a set of flat end mills—such as including a high-speed end mill, a steel end mill, a carbide end mill, etc.—of the tool type specified by the first machining operation.

The computer system can repeat this process for each machining operation in the sequence of machining operations defined by the selected recommended machining strategy. For example, the computer system can receive selection of a recommended machining strategy defining: a first machining operation specifying a first tool type; and a second machining operation specifying a second tool type. The computer system can then present the user with: a first set of cutting tools—of the first tool type—for implementation during execution of the first machining operation; and a second set of cutting tools—of the second tool type—for implementation during execution of the second machining operation.

In particular, in one example, the computer system can: initially serve the user the first set of cutting tools and a first prompt to select a first cutting tool from the first set of cutting tools for implementing during execution of the first machining operation; and, upon selection of a particular cutting tool from the first set of cutting tools by the user, serve the user the second set of cutting tools and a second prompt to select a second cutting tool from the second set of cutting tools for implementing during execution of the second machining operation.

In one implementation, Block S180 of the method S100 recites: accessing a suite of tools accessible for execution of machining operations at the machining facility. In this implementation, the computer system can leverage a local tool library—defining a suite of cutting tools—generated for the machining facility to selectively suggest cutting tools to the user responsive to the request.

For example, in this implementation, the computer system can: receive selection of a recommended machining strategy for machining a particular feature of a part at a machining facility, the recommended machining strategy defining a sequence of machining operations; and access a facility profile, in a population of facility profiles, associated with the machining facility and defining a local tool library including a suite of cutting tools available for machining parts at the machining facility. Then, for a first machining operation, in the sequence of machining operations defined for the recommended machining strategy, the computer system can: access a first tool type defined for the first machining operation; based on the suite of tools and the first tool type, select a first subset of tools, in the suite of tools, of the first tool type and predicted to achieve a set of target metrics (e.g., average torque, tool life) during execution of the first machining operation; and serve the first subset of tools to the user via the user portal.

The computer system can then repeat this process for each machining operation, in the sequence of machining operations, to serve to the user: the first subset of tools corresponding to the first machining operation; a second subset of tools, in the suite of tools, corresponding to a second machining operation in the sequence of machining operations; a third subset of tools, in the suite of tools, corresponding to a third machining operation in the sequence of machining operations; etc. The computer system can therefore suggest cutting tools—for implementing during execution of a selected recommended machining strategy at the automated machine—already available at the particular machining facility.

Additionally or alternatively, in another implementation, the computer system can leverage the local tool library in combination with a global tool library—such as including tools that are not currently available at the machining facility—to recommend specific cutting tools of the cutting tool type for a particular machining operation.

For example, the computer system can: generate and present the user with a set of recommended machining strategies for machining a feature of a part responsive to receipt of a request from the user; receive selection of a first recommended machining strategy, in the set of recommended machining strategies, defining a machining operation specifying a first tool type; access a local tool library—defining a local set of cutting tools—such as stored in a facility profile generated for the machining facility affiliated with the user; and, based on the local tool library, characteristics of the machining operation, and the first tool type, select a first subset of cutting tools, from the local set of cutting tools, recommended for implementing during execution of the machining operation.

Then, in the preceding example, the computer system can: access a global tool library defining a global set of cutting tools available for machining operations; and, based on the global tool library, characteristics of the machining operation, and the first tool type, select a second subset of cutting tools, from the global set of cutting tools, recommended for implementing during execution of the machining operation. The computer system can then present the user with both the first and second subset of cutting tools.

In particular, in one example, the computer system can: present the user with a set of local cutting tools (e.g., one, two, five, ten local cutting tools) available at the machining facility and of the first tool type; and present the user with a single cutting tool—currently unavailable at the machining facility—of the first tool type. Furthermore, in this example, the computer system can pair this single cutting tool—currently unavailable at the machining facility—with a set of purchase information for acquiring the cutting tool, such as including a seller of this cutting tool, a cost associated with the cutting tool, etc.

### 8.2.1 User Preferences+Cutting Tool Metrics

In one variation, the computer system can pair the suggested set of cutting tools with a set of cutting tool metrics—such as including a predicted torque, a predicted tool life, etc.—predicted for a particular cutting tool executing a particular machining operation according to a set of cutting parameters.

In particular, in this implementation, for a first cutting tool, in the set of cutting tools suggested for implementation during execution of a particular machining operation—defined by the selected machining strategy—the computer system can: access a first set of tool characteristics of the first cutting tool, such as including a tool material, a total length, a cutting diameter, a flute count or length, a shaft diameter, etc.; and derive a set of tool parameters (e.g., cutting velocity, feed rate, radial depth, axial depth) for the cutting tool based on the set of tool characteristics and characteristics of the particular machining operation (e.g., feature type, operation type, part material, feature location). Then, based on the set of tool parameters, the set of tool characteristics, and characteristics of the feature and/or part, the computer system can predict a set of tool metrics—such as including an average torque experienced by the cutting tool during execution of the first machining operation and/or a tool life of the cutting tool executing the first machining operation (e.g., represented in minutes and/or as a quantity of parts)—for the cutting tool executing the machining operation. The computer system can then repeat this process for each cutting tool in the set of cutting tools and present the set of cutting tools and corresponding tool metrics to the user via the user portal for review.

In one variation, the computer system can enable the user to select key metrics—such as including tool life, tool wear, machining time, tool time, material removal rate, thermal management, magnitude of vibrations and/or chatter, etc.—for prioritizing in generating the set of tool parameters and therefore the set of tool metrics.

In particular, in one implementation, the computer system can: serve the user an interactive feature configured to enable user selection of a set of weights assigned to a set of tool metrics—including material removal rate and tool life—for the set of cutting tools; receive a user input at the interactive feature (e.g., a slider) indicating assignment of a first weight (e.g., between zero percent and 100 percent) to material removal rate and a second weight (e.g., between zero percent and 100 percent) to tool life; access a set of tool characteristics defined for a first cutting tool in the set of cutting tools; based on the first weight, the second weight, the set of tool characteristics, define a set of tool operating parameters—such as including a first cutting speed, a first feed rate, a first depth of cut, etc.—for the first cutting tool; predict an average torque experienced by the first cutting tool during execution of a corresponding machining operation based on the first set of tool operating parameters; and predict a tool life of the first cutting tool based on the average torque and a threshold cumulative tool load defined for the first cutting tool (e.g., as described above).

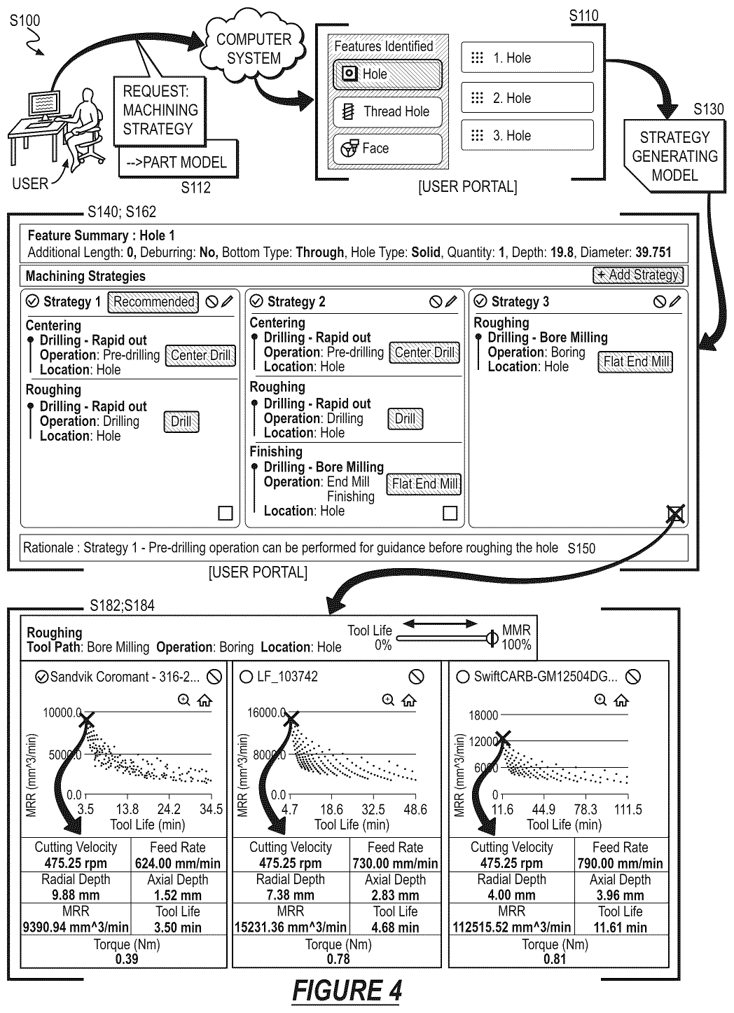

In one example, as shown in FIG. 4, the computer system can render a slider tool configured to enable the user to select a target balance between material removal rate and tool life. The computer system can then leverage placement of the slider tool by the user—such as between material removal rate and tool life—to: construct a plot representing possible combinations of material removal rate and tool life for this particular cutting tool executing a particular machining operation (e.g., roughing, centering, finishing); locate a vertex on the plot corresponding to the selection entered by the user via the slider tool; and define a set of tool parameters—including a feed rate, a cutting speed, a depth of cut, etc.—for the cutting tool based on the material removal rate and the tool life represented by the vertex on the plot. Furthermore, the computer system can leverage a placement of the slider tool by the user—in combination with the set of tool parameters—to predict a set of tool metrics including: a predicted average torque experienced by the cutting tool during execution of the particular machining operation; and a predicted tool life of the cutting tool, such as characterized by a total quantity of parts (e.g., parts-per-edge) machined via implementation the cutting tool and/or a threshold duration that the cutting tool can be exposed to the predicted average torque before experiencing wear and/or breakage.

In the preceding implementation, the computer system can similarly enable the user to selectively prioritize various key metrics—such as via selection of a set of weights assigned to these key metrics—including metrics related to tool life, tool wear, machining time, tool time, material removal rate, thermal management, magnitude of vibrations and/or chatter, etc. Based on these selections entered by the user—such as indicating prioritization of one or more of these key metrics—the computer system can automatically define tool parameters (e.g., feed rate, cutting speed, depth of cut) for one or more cutting tools and/or corresponding predicted tool metrics (e.g., a predicted average torque, a predicted tool life).

### 9. Strategy Recommendation: User Preferences

In one implementation, the computer system can leverage historical selections of machining strategies—from recommended machining strategies presented by the computer system to the user—to inform future presentation of recommended machining strategies to this user.

In one implementation, the computer system can: present a first set of recommended machining strategies for machining a first feature in a first part to a user (e.g., within the native application); receive selection of a first recommended machining strategy from the first set of recommended machining strategies; generate a first data packet containing data representing the first feature, the first set of recommended machining strategies, and selection of the first machining strategy; and store the first data packet, in a set of data packets, in a user profile associated with the user. Then, in response to receiving a request for recommended machining strategies for machining the first feature in a second part, the computer system can: implement methods and techniques described above to derive a set of recommended machining strategies for machining the first feature of the first part; access the user profile and leverage the set of data packets to filter the first set of recommended machining strategies to a subset of recommended machining strategies tailored to this user; and present the subset of recommended machining strategies to the user.

Alternatively, in another implementation, the computer system can leverage the set of data packets stored in the user profile to retrain the strategy-generating model over time based on historical user selections. The computer system can therefore train the strategy-generating model to selectively recommend machining strategies tailored to this particular user's historical preferences. Later, in response to receiving a request for recommended machining strategies for machining the first feature in a second part, the computer system can: implement methods and techniques described above to derive a set of recommended machining strategies—tailored to this particular user's preferences—for machining the first feature of the first part; and present the set of recommended machining strategies to the user.

For example, the computer system can present to the user a set of three recommended machining strategies for machining a particular feature of a part. Then, in response to the user selecting a first machining strategy, from the set of three recommended machining strategies, the computer system can generate and store a data packet, in a set of data packets, including: a value representing the particular feature; a value representing selection of the first machining strategy; and a value representing non-selection of the second and third machining strategies in the set of three recommended machining strategies. The computer system can then feed this first data packet to the strategy-generating model to retrain the strategy-generating model based on selection of the first machining strategy and non-selection of the second and third machining strategies.

### 10. Retraining the Strategy-Generating Model

Generally, the computer system can retrain the strategy-generating model over time to selectively suggest recommended machining strategies tailored to a particular machining facility.

In particular, in one implementation, the computer system can leverage historical machining data compiled for this particular machining facility—such as in combination with historical machining data compiled for a population of machining facilities—to train the strategy-generating model.

For example, the computer system can: access a corpus of machining data—such as derived from machining literature (e.g., manuals, textbooks), historical data from machining facilities, etc.—representative of machining strategies employed for machining a population of features (e.g., a pocket, a hole, a face); and train a strategy-generating model based on the corpus of machining data. Then, for a first machining facility, the computer system can: access a first set of historical machining data representative of machining strategies employed for machining features at the first machining facility; and retrain the strategy-generating model based on the first set of historical machining data. In particular, in one example, the computer system can assign a higher weight to the set of historical machining data—derived for the first machining facility—and a lower weight to the corpus of (global) machining data when retraining the strategy-generating model. Then, for a second machining facility (e.g., unaffiliated with the first machining facility), the computer system can: access a second set of historical machining data representative of machining strategies employed for machining features at the second machining facility; and retrain the strategy-generating model based on the second set of historical machining data. The computer system can therefore tailor the strategy-generating model to a particular machining facility in order to improve recommendations of machining strategies based on preferences and/or practices at this particular machining facility.

Additionally or alternatively, in another implementation, the computer system can leverage user selections of recommended machining strategies presented to the user to retrain the strategy-generating model over time (e.g., as described above). In this implementation, Block S172 of the method recites: updating (e.g., retraining) the strategy-generating model based on selection of a recommended machining strategy, in the set of recommended machining strategies presented to the user.

For example, the computer system can: receive a request for a machining strategy for machining a part defining a set of features; and implement Blocks of the method S100 to automatically generate a set of recommended machining strategies for machining a first feature—defining a first set of feature characteristics (e.g., a dimension, a size, a material, a type)—in the set of features. Then, in response to selection (e.g., by the user) of a first recommended machining strategy, in the set of recommended machining strategies generated for the first feature, the computer system can: store the first recommended machining strategy in a set of selected machining strategies selected by the user for machining the set of features of the part; represent the first set of feature characteristics of the first feature in a first training feature container; represent a first sequence of operations defined by the first recommended machining strategy in the training feature container; represent a first set of operation parameters (e.g., an operation type, a tool type) defined for the first sequence of operations in the training feature container; and update (or “retrain”) the strategy-generating model based on the training feature container to generate recommended machining strategies for machining features based on characteristics of features and preferences of the user (or machining facility).

In the preceding example, the computer system can repeat this process to generate: a second training feature container representing a second recommended machining strategy—selected by the user for machining a second feature in the set of features—paired with the second feature; a third training feature container representing a third recommended machining strategy—selected by the user for machining a third feature in the set of features—paired with the third feature; etc. The computer system can thus assemble a population of training feature containers—representing combinations of features and recommended machining strategies selected by the user for machining these features—over time based on selections entered by the user; and update the strategy-generating model based on the population of training feature containers accordingly.

### 10.1 Retraining the Strategy-Generating Model: Closing the Loop

Additionally or alternatively, in one implementation, the computer system can leverage operating data—captured at the automated machine during execution of a selected machining strategy for machining of a particular feature(s) of a part—to update (or “retrain”) the strategy-generating model.

In particular, in this implementation, Block S174 of the method S100 recites: updating (or “retraining”) the strategy-generating model based on a difference between a set of predicted operating metrics (e.g., tool loads, tool wear, cutting time, air time) and a set of operating metrics derived from machining data captured at the automated machine during machining of a set of units (e.g., one or more units) of the part.

For example, the computer system can: implement the methods and techniques described above to generate and suggest a set of recommended machining strategies for machining a particular feature of a part; and receive selection of a first recommended machining strategy, in the set of recommended machining strategies, defining a first machining operation specifying a first tool type. Then, in response to receiving selection of the first recommended machining strategy, the computer system can: selectively present the user with a set of cutting tools for execution of the first machining operation at the automated machine; for each cutting tool, in the set of cutting tools, selectively present the user with a set of target tool metrics (e.g., a target average torque, a target tool life) for the cutting tool executing the first machining operation; and receive selection of a first cutting tool, in the set of cutting tools, defining a first set of target tool metrics.

Then, in the preceding example, in response to execution of the first machining operation via the first cutting tool—such as during machining of a first instance of the particular feature in a first instance of the part at the automated machine—the computer system can: access a timeseries of machining data—such as including load data (e.g., spindle load data and/or tool load data) and/or operating data (e.g., feed rates, spindle speed, depths of cut)—captured at the automated machine during execution of the first machining operation; derive a set of tool metrics (e.g., an average torque, a tool life) for the cutting tool during execution of the first machining operation based on the timeseries of machining data; characterize a difference between the set of tool metrics and the set of target tool metrics; and update (or “retrain”) the strategy-generating model based on the difference.

In one example, the computer system can receive a request for a machining strategy for machining a part defining a set of features, and implement the strategy-generating model to: generate a first recommended machining strategy for machining a first feature of a part, the first recommended machining strategy defining a first machining operation and a first set of operation parameters—including a first tool for completing the first operation—for the first machining operation; and generate a first rationale—defining a predicted torque (e.g., an average torque) exerted on the first tool during execution of the first machining operation—for selection of the first recommended machining strategy.

Then, in the preceding example, in response to selection of the first recommended machining strategy, in the set of recommended machining strategies, by the user, the computer system can: access a timeseries of load data (e.g., spindle load data, tool load data) captured at an automated machine—configured to machine the part—during machining of the first feature according to the first recommended machining strategy; derive an average torque exerted on the first tool during execution of the first machining operation—for machining the first feature—based on the timeseries of load data; and characterize a first difference between the predicted torque and the average torque. The computer system can then update the strategy-generating model—such as in order to more accurately predict torque experienced by the first tool during execution of various operations at the automated machine—based on this first difference.

Additionally, in the preceding example, the computer system can generate the first rationale—defining a predicted tool life for the first tool executing the first machining operation—for selection of the first recommended machining strategy. Then, in response to selection of the first recommended machining strategy by the user, the computer system can: track an actual tool life of the first tool across one or more instances of executing the first machining operation based on the timeseries of load data; and characterize a second difference between the predicted tool life and the actual tool life. The computer system can then update the strategy-generating model—such as in order to more accurately predict tool life of the first tool—based on this second difference.

In particular, in one example, the computer system can: represent a first set of feature characteristics of the first feature in a first training feature container; represent the first machining operations defined by the first recommended machining strategy in the training feature container; represent the first tool—such as characterized by a tool type, a tool material, a tool diameter, a cutting length, etc.—in the first training feature container; represent the first difference between the first predicted torque and the average torque in the training feature container; represent the second difference between the predicted tool life and the actual tool life in the training feature container; and feed the training feature container into the strategy-generating model to update (or “retrain”) the strategy-generating model accordingly.

### 11. Cutting Performance

Generally, the computer system can characterize cutting performance for a particular machine, a particular program (e.g., machining program), and/or a particular cutting tool based on real-time data captured at the automated machine during machining of a part(s) and/or feature(s) of a part at the automated machine.

In one implementation, the computer system can characterize performance for a particular tool-cutting process—defining a particular machine, program, and/or cutting tool—based on a set of performance metrics captured during execution of the tool-cutting process. In particular, in this implementation, in response to receiving selection (e.g., by the user within the user portal) of a particular tool-cutting process, the computer system can: access a material-cutting time—corresponding to a duration of time during which a cutting tool actively cuts material of a workpiece—exhibited during execution of the particular tool-cutting process (e.g., a single instance, each instance during a preceding time period); access an air-cutting time—corresponding to a duration of time during which the cutting tool is not actively cutting material of the workpiece—exhibited during execution of the particular tool-cutting process; calculate a ratio of the material-cutting time to the air-cutting time; and characterize performance of the particular—program based on this ratio.

Additionally or alternatively, in another implementation, the computer system can render a set of graphical representations representative of performance of a particular machine, program, and/or cutting tool. For example, the computer system can: present a first bar graph representing a total cutting time—including available time, material-cutting time, and air-cutting time—exhibited by each machine, each program, and/or each cutting tool; and/or present a second bar graph representing total cutting time—including available time, material-cutting time, and air-cutting time—exhibited by each machine, each program, and/or each cutting tool over time.

The computer system can characterize cutting performance for any combination of machine, program, and/or cutting tool selected by the user (e.g., via the user portal). For example, the user may access the user portal and select a first machine, a first program, and a first cutting tool. The computer system can then: receive a first request for performance data associated with a first tool-cutting process defined by the first machine, the first program, and the first cutting tool; characterize performance of this first tool-cutting process accordingly; and present a first set of performance data for this first tool-cutting process to the user within the user portal.

Additionally or alternatively, within the user portal, the user may select the first machine, the first program, and a second cutting tool. The computer system can then: receive a second request for performance data associated with a second tool-cutting process—distinct from the first tool-cutting process—defined by the first machine, the first program, and the second cutting tool; characterize performance of this second tool-cutting process accordingly; and present a second set of performance data for this second tool-cutting process to the user within the user portal.

### 11.1 Variation: Operator Performance

In one variation, the computer system can leverage performance metrics-derived for a particular machine, program, and/or cutting tool—to characterize performance of an operator (e.g., a human operator) operating the automated machine during a particular time period.

In particular, in this variation, the computer system can: isolate a subset of performance metrics corresponding to work period for an operator; and leverage this subset of performance metrics to derive insights into performance of the operator and/or selectively suggest actions predicted to improve operator performance. For example, for a particular tool-cutting process, the computer system can: derive an air-cutting time for a cutting tool—associated with the particular tool-cutting process—during a working period for an operator assigned to this particular tool-cutting process; derive a material-cutting time for the cutting tool during the working period; and, in response to the material-cutting time falling below a target material-cutting time defined for the tool-cutting process, flag this operator for additional training configured to increase material-cutting time for this operator. The computer system can similarly repeat this process for each operator, in a population of operators, to promote an increase in operator performance, and therefore overall cutting performance, for this particular tool-cutting process.

### 11.2 Tool Utilization

In one implementation, the computer system can monitor tool utilization for a particular machine, program, and/or cutting tool. In particular, in this implementation, the computer system can track a set of tool utilization metrics—representing utilization of a particular tool or group of tools employed by an automated machine during execution of one or more programs. For example, the computer system can track: a quantity of units of a particular cutting tool implemented during execution of a particular tool-cutting process over time; a quantity of different cutting tools implemented during execution of a program—defining one or more tool-cutting processes—over time; a quantity of tools implemented on a particular machine over time; a tool life (e.g., a cutting duration) of each tool implemented on the automated machine over time; etc.

Furthermore, the computer system can monitor these utilization metrics over time and selectively notify the user of changes in these metrics. Based on changes in these utilization metrics over time, the computer system can derive insights related to tool utilization for a particular machine, program, and/or cutting tool.

### 11.3 User Notifications

The computer system can selectively transmit notifications to the user regarding cutting performance and/or tool utilization. Furthermore, the computer system can selectively suggest a particular action for the user to implement responsive to changes in cutting performance and/or tool utilization for a particular machine, program, and/or cutting tool over time

For example, in response to characterizing cutting performance—such as characterized by an average material-cutting time and an average air-cutting time—for a particular machine as below a target cutting performance defined for this particular machine, the computer system can: generate a notification indicating low cutting performance of the automated machine and including a suggestion to investigate the automated machine; and transmit the notification to the user via the user portal. In a similar example, in response to detecting an air-cutting time falling below an average air-cutting time defined for a particular program, the computer system can: generate a notification indicating a below-average air-cutting time for the program and including a suggestion to investigate the program; and transmit the notification to the user via the user portal.

### 12. Monitoring Tool Load

Block S240 of the method S200 recites: accessing a first timeseries of load data (e.g., spindle load data) output by a set of sensors integrated into the automated machine during execution of a first tool-cutting process via a first cutting tool. Furthermore, Block S250 of the method S200 recites: generating a first load profile for the tool-cutting process based on the first timeseries of load data, the first load profile representing change in loads experienced by a first instance of the first cutting tool implemented during execution of the first tool-cutting process.

Generally, the computer system can leverage real-time load data—such as including timeseries spindle loads-captured at and output by the automated machine to assemble a tool load profile representing change in tool load experienced by a particular cutting tool during execution of a tool-cutting process corresponding to the particular cutting tool.

In one implementation, the computer system can monitor and/or track tool load—corresponding to (e.g., proportional) an amount of work experienced by a cutting tool—for a particular cutting tool. In particular, in this implementation, the computer system can track time series load data—representing change in tool load experienced by a particular cutting tool over time—for this particular cutting tool based on time series spindle loads output by the automated machine (e.g., a CNC machine) during execution of a particular tool-cutting process via the particular cutting tool. The computer system can then leverage this time series load data to interpret instances of risk events—such as including a fault event, a tool override event, a tool disengagement event, a rate change event—during execution of the particular tool-cutting process.

For example, the computer system can: access a time series of spindle load data captured by the automated machine during execution of a program defined for machining a particular part and representing change in spindle load—such as represented as a percentage of a maximum spindle load defined for the automated machine—throughout execution of the program; isolate a subset of spindle load data, in the time series of spindle load data, corresponding to a particular cutting tool; and leverage this subset of spindle load data to interpret a time series of tool load data—such as proportional to and/or approximating the time series spindle load data—representing tool loads experienced by the particular cutting tool during execution of a tool-cutting process, within the program, corresponding to this particular cutting tool. Based on this time series of tool load data, the computer system can derive a tool load profile (e.g., a tool load curve) representing change in tool load experienced by the particular tool throughout execution of the tool-cutting process.

The computer system can then leverage this tool load profile—generated for the tool-cutting process associated with this particular cutting tool—to derive a process record representative of this instance of the tool-cutting process. For example, the computer system can: interpret timestamped instances of risk events—such as including a fault event, an override event, a disengagement event, a rate of change event—based on features of the tool load profile derived for this instance of the tool-cutting process. The computer system can then represent these timestamped instances of risk events in a process record generated for this particular instance of the tool-cutting process. Additionally or alternatively, in this example, the computer system can derive and/or access a set of process metrics—such as including a material-cutting time, an air-cutting time, a total cutting time, a feature and/or part quality, a quantity of risk events, etc.—corresponding to this instance of the tool-cutting process and represent this set of process metrics in the process record.

### 12.1 Baseline Tool Load Profile

Block S220 of the method S200 recites: accessing a baseline load profile defined for execution of a first tool-cutting process, in a set of tool-cutting processes of a machining program defined for machining units of a first part at an automated machine, the first tool-cutting process corresponding to a sequence of operations executed via implementation of a first cutting tool, in a set of cutting tools, during machining of a unit of the first part.

Generally, the computer system can access a baseline load profile—representing change in load experienced by a particular cutting tool executing a tool-cutting process at the automated machine—defined for the particular cutting tool and/or tool-cutting process.

For example, the computer system can: retrieve a program—defining a sequence of machining operations executed by an automated machine via a set of cutting tools—for machining a part defining a set of features; access a first baseline load profile defined for a first tool-cutting process—corresponding to a first subset of machining operations, in the sequence of machining operations, executed by a first cutting tool in the set of cutting tools—representing change in load experienced by the first cutting tool during execution of the first subset of machining operations at the automated machine; and access a second baseline load profile defined for a second tool-cutting process—corresponding to a second subset of machining operations, in the sequence of machining operations, executed by a second cutting tool in the set of cutting tools—representing change in load experienced by the second cutting tool during execution of the second subset of machining operations at the automated machine.

In one implementation, as described further below, the computer system can automatically generate a baseline load profile for a tool-cutting process—defining a particular cutting tool and a subset of machining operations in a sequence of machining operations executed to machine a part—based on initial timeseries load data captured at the automated machine across one or more instances of the tool-cutting process. Additionally or alternatively, in another implementation, as described further below, the computer system can predict a baseline load profile for the tool-cutting process, such as based on characteristics of the cutting tool, characteristics of the subset of machining operations (e.g., defined by the corresponding machining strategy), various operating parameters (e.g., cutting speed, feed rate, depth of cut) at the automated machine, etc.

### 12.1.1 Baseline Tool Load Profile: Initial Timeseries Data

In one implementation, the computer system can derive a baseline tool load profile (hereinafter “baseline load profile”) for a particular tool-cutting process—defining a particular combination of an automated machine, a program, and/or a cutting tool—based on historical time series tool load data captured for this particular tool-cutting process.

For example, during an initial setup period, the computer system can: access a first tool load experienced by the cutting tool at a first time during execution of a first instance of the tool-cutting process; access a first time value corresponding to the first time; access a second tool load experienced by the cutting tool at a second time, succeeding the first time, during execution of the first instance of the tool-cutting process; access a second time value corresponding to the second time; access a third tool load experienced by the cutting tool at a third time, succeeding the second time, during execution of the first instance of the tool-cutting process; access a third time value corresponding to the third time; and generate a first time series of tool load data based on the first tool load, the first time value, the second tool load, the second time value, the third tool load, and the third time value. Then, the computer system can: characterize a baseline load profile—representative of changes in tool load experienced by the cutting tool during execution of the first instance of the tool-cutting process—based on the first time series of tool load data, such as by interpolating tool load between the first, second, and third timestamps.

The computer system can then repeat this process for each tool-cutting process, in the set of tool-cutting processes of a program, to generate a baseline load profile—including a set of load profiles, each load profile, in the set of load profiles, linked to a particular tool-cutting process, in the set of tool-cutting processes—representative of changes in tool load experienced by the set of tools implemented during execution of the program during the initial time period.

Furthermore, the computer system can continue to update this baseline load profile over time as the computer system collects additional tool load data for this space, such as based on additional time series of tool load data collected over subsequent time periods during execution of the tool-cutting process. For example, during a first time period succeeding the initial time period, the computer system can: access a fourth tool load experienced by the cutting tool at a fourth time—corresponding to the first time—during execution of a second instance of the tool-cutting process; access a fourth time value corresponding to the fourth time; access a fifth tool load experienced by the cutting tool at a fifth time, succeeding the fourth time and corresponding to the second time, during execution of the second instance of the tool-cutting process; access a fifth time value corresponding to the fifth time; access a sixth tool load experienced by the cutting tool at a sixth time, succeeding the fifth time and corresponding to the third time, during execution of the second instance of the tool-cutting process; access a sixth time value corresponding to the sixth time; and generate a second time series of tool load data based on the fourth, fifth, and sixth tool loads and the fourth, fifth, and sixth time values. The computer system can then: derive a second tool load profile—representing change in tool load experienced by the tool during execution of the second instance of the tool-cutting process—based on the second time series of tool load data; and update the baseline load profile—derived for the tool-cutting process—based on this tool load profile.

In one example, the computer system can update the baseline load profile over time by calculating an average of historical time series load data derived for this particular tool-cutting process. Additionally or alternatively, in another example, the computer system can assign a greater weight to load data captured during recent instances of the tool-cutting process and assign a lower weight to load data captured during preceding instances of the tool-cutting process. Additionally or alternatively, in another example, the computer system can define a rolling time window (e.g., 24 hours, 1 week, 1 month, 1 year) and leverage load data collected for this tool-cutting process during the rolling time window to derive a baseline load profile for the tool-cutting process.

Additionally or alternatively, in one implementation, the computer system can generate a dynamic baseline load profile—for execution of a particular tool-cutting process at a particular automated machine (and/or for a particular end user)—configured to account for fluctuations in timing and/or duration of the particular tool-cutting process, such as across multiple iterations of the particular tool-cutting process. For example, the computer system can implement artificial intelligence, machine learning, regression, deep learning, and/or other techniques to train a baseline load “model”—such as a neural network, a long short-term memory model, a decision tree, a basin-hopping model, a machine-learning model, or any other type of model—to return one or more recommended machining strategies for a feature based on specified characteristics of this feature.

In particular, in one example, the computer system can: access the initial timeseries load data derived for a particular tool-cutting process at a particular automated machine; and implement machine learning to derive a baseline load “model” (i.e., the dynamic baseline load profile)—such as an RNN model (or “recurring neural network”) and/or an LSTM model (or “long short-term memory” model) incorporating dynamic time-warping algorithms—for this particular tool-cutting process based on the initial timeseries load data and observed patterns in load data represented in this initial timeseries load data. The computer system can then implement this baseline load model during execution of the tool-cutting process to: predict expected baseline loads at any point during execution of the tool-cutting process, such as based on detected patterns in change in load and agnostic and/or semi-agnostic to exact timing of these changes during the tool-cutting process; and therefore more accurately detect deviations in actual (real-time) loads from expected loads defined by the baseline load model, thereby reducing risk of false positives in identifying risk events (e.g., overload, disengagement) at the automated machine and/or increasing precision and/or accuracy in adjustment of operating parameters (e.g., feed rate, cutting speed) at the automated machine accordingly.

### 12.1.2 Baseline Tool Load Profile: Predicted Loads

In one variation, the computer system can predict a “baseline” load profile (or “target load profile”) for the tool-cutting process, such as based on characteristics of the cutting tool, characteristics of the subset of machining operations executed by the cutting tool, various operating parameters (e.g., cutting speed, feed rate, depth of cut) implemented at the automated machine during execution of the tool-cutting process, etc.

For example, for a first tool-cutting process executed via implementation of a first cutting tool, the computer system can: access a first set of operating parameters—such as including a first feed rate and a first cutting speed of the first cutting tool (e.g., during execution of a first machining operation)—defined for execution of the first tool-cutting process; access a set of tool characteristics of the first cutting tool, such as including tool material, total length, cutting diameter, etc.; a set of part characteristics of a part machined via implementation of the first tool-cutting process, such as including a part material, feature characteristics, etc.; and estimate the baseline load profile for the first tool-cutting process based on the first set of operating parameters, the set of tool characteristics of the first cutting tool, and the set of part characteristics of the part.

In one implementation, the computer system can leverage predicted tool metrics generated for a recommended machining strategy—such as including a predicted average torque experienced by a cutting tool during execution of a particular machining operation (e.g., in a subset of machining operations defining a tool-cutting process)—in combination with tool path data generated for a program implementing the recommended machining strategy to generate a “baseline” load profile for the particular machining operation. In particular, the computer system can: leverage tool path data—in combination with feature and/or part characteristics (e.g., materials, dimensions), defined operating parameters (e.g., feed rate, cutting speed, depth of cut), etc.—to predict a series of loads (e.g., spindle and/or tool loads) at each point along a defined tool path; and assemble a target load profile (i.e., the baseline load profile) based on the series of loads accordingly.

### 12.2 Upper & Lower Threshold Tool Loads

The computer system can leverage the baseline load profile—derived for a particular tool-cutting process—to derive dynamic upper and lower threshold loads for the cutting tool associated with this particular tool-cutting process.

In particular, in one implementation, the computer system can: retrieve a baseline load profile—representing change in tool load experienced by a particular cutting tool during execution of a tool-cutting process—derived from historical time series load data captured for this cutting tool during execution of the tool-cutting process; derive an upper threshold load profile—defining an upper threshold tool load exceeding a baseline tool load exhibited at each timepoint throughout execution of the tool-cutting process; and derive a lower threshold load profile—defining a lower threshold tool load falling below the baseline tool load exhibited at each timepoint throughout execution of the tool-cutting process. The computer system can therefore define dynamic upper and lower limits for tool load (e.g., represented by the upper threshold load profile)—experienced by this particular cutting tool during execution of this particular tool-cutting process—based on the baseline tool load profile derived for this tool-cutting process.

In one implementation, the computer system can derive the upper and lower threshold load profiles based on a default deviation defined for upper and lower threshold load profiles. For example, the computer system can: automatically set the upper threshold load profile to define tool loads exceeding tool loads exhibited by the baseline load profile by a fixed deviation of 10 percent; and automatically set the lower threshold load profile to define tool loads falling below tool loads exhibited by the baseline load profile by the fixed deviation of 10 percent. Additionally or alternatively, in another implementation, the computer system can prompt the user to select a target deviation (e.g., 5 percent, 10 percent, 25 percent), such as based on a tolerance for risk and/or error during execution of the tool-cutting process.

Additionally or alternatively, in yet another implementation, the computer system can define the upper and lower threshold load profiles based on observed variance in tool load across historical load profiles derived for the tool-cutting process. In particular, in this implementation, the computer system can: retrieve a corpus of historical tool load profiles derived for each executed instance of the tool-cutting process; characterize variance in tool load—such as at each timepoint and/or step throughout execution of the tool-cutting process—across the corpus of historical tool load profiles; and selectively derive upper and lower threshold profiles for the tool-cutting process based on this variance.

For example, the computer system can: retrieve a first tool load profile representing a first time series of tool load data collected during execution of a first instance of the tool-cutting process; retrieve a second tool load profile representing a second time series of tool load data collected during execution of a second instance of the tool-cutting process; retrieve a third tool load profile representing a third time series of tool load data collected during execution of a third instance of the tool-cutting process; and derive a baseline tool load profile for the tool-cutting process based on the first, second, and third tool load profiles. The computer system can then: characterize a first variance (e.g., a dynamic variance) between the first tool load profile and the baseline tool load profile; characterize a second variance between the second tool load profile and the baseline tool load profile; characterize a third variance between the third tool load profile and the baseline tool load profile; and characterize a total variance—such as represented by a (dynamic) variance profile—across the corpus of tool load profiles based on the first, second, and third variances. The computer system can then leverage this total variance to define the upper and lower threshold profiles, such as spanning a range corresponding to (e.g., proportional, equivalent) the total variance.

### 12.3 Target Cumulative Tool Load

Block S226 of the method S200 recites: defining a target cumulative tool load experienced by the first cutting tool during execution of an instance of the first tool-cutting process based on the baseline load profile.

Generally, the computer system can leverage the baseline load profile generated for a particular tool-cutting process—and representative of change in load experienced by a particular cutting tool executing the particular tool-cutting process at the automated machine—to define a target cumulative tool load experienced by the particular cutting tool over a duration of the particular tool-cutting process.

For example, the computer system can: access a baseline load profile defined for execution of a first tool-cutting process—corresponding to a subset of machining operations, in a sequence of machining operations defined by a machining program, executed via implementation of a first cutting tool—representing timeseries loads experienced by the first cutting tool over a duration of the first tool-cutting process; and integrate the baseline load profile to derive a target cumulative tool load—corresponding to a total load experienced by the first cutting tool during execution of the first tool-cutting process—for the first tool-cutting process.

The computer system can then repeat this process for each tool-cutting process in a set of tool-cutting process defined for a program defining a sequence of machining operations for machining a part. For example, the computer system can: define a first target cumulative tool load for the first tool-cutting process—corresponding to a first subset of machining operations in the sequence of operations—executed via implementation of the first cutting tool; define a second target cumulative tool load for a second tool-cutting process—corresponding to a second subset of machining operations in the sequence of operations—executed via implementation of a second cutting tool; define a third target cumulative tool load for a third tool-cutting process—corresponding to a third subset of operation in the sequence of operations—executed via implementation of a third cutting tool; etc.

### 13. Process Updates

In one implementation, Block S230 of the method S100 recites: triggering the automated machine to regulate tool load experienced by the first cutting tool according to the upper baseline tool load profile and the lower baseline tool load profile.

In this implementation, the computer system can feed these upper and lower threshold load profiles to the automated machine in order to regulate tool load—experienced by the cutting tool during execution of the tool-cutting process—within the upper and lower threshold load profiles. In particular, the computer system can trigger the automated machine to regulate a set of operating parameters—such as including a feed rate and/or a spindle speed—in order to regulate tool load (e.g., represented by spindle load) according to the upper and lower threshold load profiles.

By leveraging these upper and lower threshold load profiles to regulate the set of operating parameters, the computer system can promote reduction in quantity of error or risk events experienced during execution of the tool-cutting process and/or promote improved quality of resulting parts machined via the tool-cutting process.

### 13.1 Predictions

In one variation, the computer system can predict a future tool load—experienced by the cutting tool during execution of the tool-cutting process—based on a current tool load experienced by the cutting tool and the baseline tool load profile derived for the cutting tool. In this variation, the computer system can implement machine learning, regression, artificial intelligence, deep learning, and/or other techniques to train a neural network (e.g., via long short-term memory networks and/or gated recurrent units) to output predicted tool loads for a particular tool-cutting process based on historical and/or real-time tool load data collected for the tool-cutting process.

For example, during execution of the tool-cutting process, the computer system can: access a first spindle load output by the automated machine at a first time during execution of the tool-cutting process; access a second spindle load output by the automated machine at a second time succeeding the first time; and assemble a tool load profile for the cutting tool based on the first spindle load at the first time and the second spindle load at the second time. Then, the computer system can: retrieve the baseline tool load profile derived for the tool-cutting process; estimate a baseline load difference between a first baseline tool load at the first time in the baseline tool load profile and a second baseline tool load at the second time in the baseline tool load profile; estimate a first tool load difference between a first tool load at the first time in the tool load profile and a second tool load at the second time in the tool load profile; characterize a difference between the baseline load difference and the first tool load difference; and, based on the difference, predict a third tool load—at a third time succeeding the second time—experienced by the cutting tool at the (future) third time.

The computer system can similarly predict a complete tool load profile for an incomplete tool-cutting process based on tool load data captured during an initial time period during execution of the tool-cutting process. Based on the predicted tool load profile and/or predicted tool load, the computer system can selectively implement actions—such as by automatically triggering the automated machine to execute an action and/or by notifying a user to implement an action—configured to prevent deviations from the baseline load profile (e.g., deviations above the upper threshold and/or below the lower threshold) and therefore preemptively act on predicted instances of risk events that may lead to a decrease in part quality, re-machining of parts, and/or premature or delayed tool changes.

In particular, in one implementation, the computer system can trigger the automated machine to execute an action—configured to regulate tool load toward a target tool load defined by the baseline tool load profile (or within the upper and lower threshold tool load profiles)—responsive to a predicted tool load falling outside the upper and lower threshold load profiles defined for the tool-cutting process. For example, in response to predicting a (future) tool load outside a target range defined by the upper and lower threshold load profiles, the computer system can: select an action configured to drive the tool load to within the target range, such as increasing or decreasing a feed rate and/or spindle speed implemented by the automated machine for the tool-cutting process; and trigger the automated machine to implement this action in real-time and/or during subsequent instances of the tool-cutting process. The computer system can thus leverage both observed and predicted tool loads to inform modifications in the tool-cutting process as implemented by the automated machine.

### 13.2 Risk Events

Block S260 of the method S200 recites: in response to the tool load profile defining a tool load falling outside the upper baseline tool load profile and the lower baseline tool load profile at a first time, interpreting a first risk event at the automated machine at the first time.

Generally, the computer system can leverage deviations from the baseline load profile—and/or outside of the upper and lower baseline load profiles (e.g., loads exceeding the upper baseline load profile, loads falling below the lower baseline load profile)—to detect instances of risk events at the automated machine, such as corresponding to a fault event, an override event, a disengagement event, etc.

In one implementation, the computer system can therefore leverage the upper and lower threshold load profiles—derived for a particular tool-cutting process—to interpret instances of these risk events (e.g., fault event, override event, disengagement event) during and/or after execution of the tool-cutting process. The computer system can thus notify the user of detected risk events, such as in (near) real-time and/or post-hoc in a record for review by the user.

In one variation, the computer system can characterize risk—such as risk associated with part quality or defects and/or material loss due to part defects—associated with a particular machine, program, and/or cutting tool.

In particular, in this variation, the computer system can track a set of risk metrics and characterize risk for a particular tool-cutting process based on this set of risk metrics. For example, for each machine, program, and/or cutting tool, the computer system can track: a quantity of fault events; a quantity of override events; a quantity of tool disengagement events, such as corresponding to a tool load falling below a lower threshold tool load defined by the lower threshold load profile; a quantity of tool overload events, such as corresponding to a tool load exceeding an upper threshold tool load defined by the upper threshold load profile; a quantity of rate of change events, such as corresponding to an increase or decrease in tool load at a rate falling below a lower threshold rate or an upper threshold rate, respectively; etc.

### 13.3 Real-Time Actions

Block S262 of the method S200 recites: selecting a first action, in a set of actions, configured to mitigate the first risk event; and triggering the automated machine to implement the first action.

Generally, in response to detecting a risk event (e.g., an overload event, a disengagement event) occurring at the automated machine, the computer system can selectively trigger the automated machine to execute an action configured to mitigate the risk event. The computer system can implement these actions in order to minimize resource spend—such as related to costs, labor, materials (e.g., parts, tools), etc.—associated with these risk events.

In one implementation, the computer system can selectively execute and/or suggest an action based on detection of risk events during execution of a tool-cutting process. In particular, in this implementation, the computer system can: retrieve a baseline load profile defined for the tool-cutting process; access timeseries load data output by the automated machine during execution of the tool-cutting process; assemble a tool load profile for the cutting tool associated with the tool-cutting process based on the timeseries load data, such as in (near) real-time; characterize a difference between the baseline load profile and the (current) tool load profile; and—based on the difference—interpret an instance of a risk event. The computer system can then selectively notify a user of the instance of the risk event and/or automatically execute an action configured to rectify and/or limit risk associated with the risk event. For example, the computer system can prompt the user to investigate the automated machine and/or cutting tool and/or select a different cutting tool.

For example, during execution of the tool-cutting process at the automated machine, the computer system can: access upper and lower baseline load profiles generated for the tool-cutting process (e.g., as described above); trigger the automated machine to execute the first tool-cutting process according to a first set of operating parameters predicted to regulate tool load experienced by the first cutting tool between the upper baseline load profile and the lower baseline load profile defined for the tool-cutting process; access a timeseries of tool load data representing tool load experienced by the first cutting tool during execution of the tool-cutting process; and derive a tool load profile for the tool-cutting process based on the timeseries of tool load data. Then, in response to the tool load profile defining a tool load falling outside the upper baseline load profile and the lower baseline load profile at a first time, the computer system can: select a second set of operating parameters—predicted to drive tool load experienced by the first cutting tool between the upper baseline load profile and the lower baseline load profile—for the first tool-cutting process in replacement of the first operating parameters; and automatically trigger the automated machine to continue executing the first instance of the first tool-cutting process according to the second set of operating parameters.

In one example, in response to a current tool load exceeding an upper tool load defined for a particular timepoint during execution of the tool-cutting process, the computer system can: flag this particular timepoint as corresponding to a tool overload event; generate a notification indicating detection of the tool overload event; transmit the notification to the user (e.g., via the user portal) for review; automatically pause execution of the tool-cutting process; and/or automatically transmit a signal to the automated machine to adjust (e.g., increase, reduce) a feed rate and/or a spindle speed implemented for the tool-cutting process. In another example, in response to a rate of change in tool load—such as measured over a particular timespan during execution of the tool-cutting process—exceeding a threshold rate of change defined by the baseline load profile, the computer system can flag this timespan as corresponding to a rate of change event and similarly notify the user and/or selectively implement an action configured to limit risk associated with the rate of change event.

In yet another example, in response to a current tool load falling below a lower tool load defined for a particular timepoint during execution of the tool-cutting process, the computer system can: flag this particular timepoint as corresponding to a tool disengagement event; generate a notification indicating detection of the tool disengagement event; transmit the notification to the user (e.g., via the user portal); automatically pause execution of the tool-cutting process; and/or automatically transmit a signal to the automated machine to adjust (e.g., increase, reduce) a feed rate and/or a spindle speed implemented for the tool-cutting process.

### 14. Tool Life

In one variation, the computer system can track tool life for a particular cutting tool based on a real-time tool load profile derived for this particular cutting tool.

### 14.1 Tool Life: Threshold Cumulative Tool Load

In particular, in this variation, the computer system can define a threshold cumulative tool load (e.g., a maximum tool load)—representing a maximum cumulative tool load experienced by a cutting tool across execution of one or more tool-cutting processes—for a total tool life of the cutting tool, such that the cutting tool may be discarded and/or replaced upon experiencing a cumulative tool load at and/or exceeding the threshold cumulative tool load. Then, during execution of one or more tool-cutting processes implementing the cutting tool, the computer system can: access time series load data representing tool loads experienced by the cutting tool over time during execution of these tool-cutting processes; track a cumulative tool load experienced by the cutting tool across all machining applications implementing this particular cutting tool; and, based on the cumulative tool load and the threshold cumulative tool load, characterize a remaining tool life of the cutting tool.

In one implementation, the computer system can define the threshold cumulative tool load—corresponding to the maximum tool life of the cutting tool—based on a known quantity of units of a part machined via the cutting tool at the total tool life. In particular, in this implementation, the computer system can: access a quantity of parts machined via implementation of a cutting tool—throughout a tool life of the cutting tool (e.g., 10 parts-per-edge, 100 parts-per-edge, 1,000 parts-per-edge)—at a maximum tool life of the cutting tool; retrieve a timeseries of load data captured for the cutting tool during execution of a tool-cutting process—in a set of tool-cutting processes of a program defined for the part—throughout the tool life of the cutting tool; calculate a baseline cumulative tool load experienced by the cutting tool throughout the tool life of the cutting tool based on the timeseries of load data; and define a threshold cumulative tool load—associated with the maximum tool life of the cutting tool—corresponding to the baseline cumulative tool load.

Therefore, rather than define a static, maximum tool life for the cutting tool—after which the user may discard and/or replace the cutting tool with a new cutting tool—the computer system can define a dynamic tool life for the cutting tool based on the amount of work (or “tool load”) experienced by the cutting tool.

The computer system can then leverage this defined target tool life—associated with the maximum tool life of the cutting tool—to selectively prompt the user to discard and/or replace the cutting tool during execution of the tool-cutting process, such as in response to the cumulative tool load experienced by the cutting tool falling within a threshold difference of the threshold cumulative tool load and prior to the cumulative tool load exceeding the threshold cumulative tool load. Furthermore, the computer system can present real-time estimates of a remaining tool life (e.g., a remaining quantity of parts) for the cutting tool—such as by rendering a tool load “gauge” depicting a proportion of the threshold cumulative tool load experienced by the cutting tool and a proportion of the threshold cumulative tool load remaining—within the instance of the user portal, such that the user may monitor the remaining tool life and prepare to replace the cutting tool as needed.

The computer system can therefore enable the user to: replace the cutting tool with a new cutting tool prior to breakage of the cutting tool and/or decrease in tool functionality (e.g., below a threshold), thereby limiting reduction in part quality, minimizing machining errors, and/or minimizing material waste due to machine or quality errors that result in re-machining of parts; and withhold replacing of the cutting tool prior to the cumulative tool load experienced by the cutting tool falling within a threshold difference of the threshold cumulative tool load, thereby reducing tool waste and costs associated with cutting tool replacement and/or increasing through-put by limiting time spent replacing and/or changing cutting tools.

In one example, for a cutting-tool process implementing a cutting tool—in a set of cutting tools implemented during execution of a program for machining units of a particular part on an automated machine—the computer system can: track a cumulative tool load experienced by a first instance of the cutting tool during a first time period; and track a quantity of units of the particular part machined on the automated machine during the first time period. Then, at a first time during this first time period, the user may manually replace the first instance of the cutting tool—such as based on the user's knowledge of tool life for instances of the cutting tool and/or manual assessment of the first instance of the cutting tool—and provide confirmation of replacement of the first instance of the cutting tool to the computer system. The computer system can then prompt the user to confirm that a tool life of the first instance of the cutting tool at the first time corresponds to a maximum tool life of the cutting tool. Then, in response to receiving confirmation of the maximum tool life of the cutting tool, the computer system can: retrieve the cumulative tool load experienced by the first instance of the cutting tool at the first time; and set this cumulative tool load as the threshold cumulative tool load for this tool-cutting process. Later, the computer system can: track a cumulative tool load experienced by a second instance of the cutting tool—during execution of the tool-cutting process—during a second time period succeeding the first time period; and, in response to the cumulative tool load falling within a threshold deviation of the threshold cumulative tool load, automatically pause machining of units of the part and notify the user to replace the second instance of the cutting tool.

### 14.2 Tool Life: Target Quantity of Parts Machined

In one implementation, the computer system can represent tool life of a cutting tool as a quantity of parts machined via implementation of a single instance of the cutting tool, such as prior to breakage and/or deterioration of the cutting tool.

For example, the computer system can: access a baseline load profile defined for the tool-cutting process; based on the baseline load profile, define a target cumulative tool load experienced by the first cutting tool—during machining of each unit of the part—for each instance of the tool-cutting process; access a threshold cumulative tool load defined for the first cutting tool and corresponding to a maximum tool life of the first cutting tool; and, based on the threshold cumulative tool load and the target cumulative tool load, derive a target quantity of units of the first part for machining via implementation of a first instance of the first cutting tool. In particular, in one example, the computer system can derive the target quantity of units of the first part—for machining via implementation of a single instance of the cutting tool and corresponding to a maximum tool life of the instance of the cutting tool—as a ratio of the threshold cumulative tool load to the target cumulative tool load.

The computer system can then present this target quantity of units of the part to the user via the user portal. Furthermore, the computer system can: represent a tool life of the cutting tool based on a difference between a quantity of units of a part machined via an instance of the cutting tool and the target quantity; and present the tool life to the user via the user portal, such as during machining of a population of units of the part.

### 14.3 Tracking Tool Life: Selective Actions

In one implementation, the computer system can selectively implement an action—such as during and/or succeeding execution of a tool-cutting process via implementation of an instance of a particular cutting tool—based on a current tool life of this instance of the particular cutting tool.

### 14.3.1 Actions: Cutting Tool Replacement

In one implementation, the computer system can selectively prompt the user—affiliated with the machining facility—to replace a first instance of a cutting tool with a second instance of the cutting tool based on the cumulative tool load experienced by the cutting tool.

For example, in this implementation, the computer system can: access a threshold cumulative tool load defined for a cutting tool and corresponding to a maximum tool life of the cutting tool; during execution of a tool-cutting process—implementing a first instance of the cutting tool—corresponding to machining of a first unit of a part, track a cumulative tool load experienced by the cutting tool (e.g., as described above); and characterize a difference between the cumulative tool load and the threshold cumulative tool load defined for the cutting tool. Then, based on the difference—such as in response to the difference falling below a threshold difference—the computer system can: generate a prompt to install a second instance of the cutting tool in replacement of the first instance of the cutting tool prior to execution of a second instance of the tool-cutting process corresponding to machining of a second unit of the part; and transmit the prompt to a user affiliated with the automated machine via an instance of the user portal.

Additionally or alternatively, in another implementation, the computer system can selectively trigger the automated machine to automatically replace a first instance of a cutting tool with a second instance of the cutting tool based on the cumulative tool load experienced by the cutting tool.

For example, in this implementation, the computer system can: access a threshold cumulative tool load defined for the cutting tool and corresponding to a maximum tool life of the cutting tool; during execution of a tool-cutting process—implementing a first instance of the cutting tool—corresponding to machining of a first unit of a part, track a cumulative tool load experienced by the cutting tool; and characterize a difference between the cumulative tool load and the threshold cumulative tool load defined for the cutting tool. Then, in response to the difference falling below a threshold difference, the computer system can trigger the automated machine to replace the first instance of the cutting tool with a second instance of the cutting tool prior to execution of a second instance of the first tool-cutting process corresponding to machining of a second unit of the first part.

### 14.3.2 Actions: Real-Time Adjustment of Operating Parameters

In one implementation, Blocks of the method S200 recite: tracking a cumulative tool load experienced by the first instance of the first cutting tool based on the first load profile—representing change in loads experienced by a first cutting tool implemented during execution of a tool-cutting process—in Block S252; and characterizing a difference between the cumulative tool load experienced by the first instance of the first cutting tool and the target cumulative tool load defined for the tool-cutting process.

Furthermore, Blocks of the method S200 recite: selecting a second set of operating parameters for the tool-cutting process, the second set of operating parameters including a second feed rate and a second cutting speed of the first cutting tool; and triggering the automated machine to execute the tool-cutting process via the first instance of the first cutting tool according to the second set of operating parameters in replacement of a first set of operating parameters—including a first feed rate and a first cutting speed of the first cutting tool—in Block S262.

Generally, in this implementation, the computer system can update a set of operating parameters—such as including a cutting speed, a feed rate, a depth of cut, etc.—implemented by the automated machine during execution of a tool-cutting process in order to extend tool life of the cutting tool corresponding to the tool-cutting process.

In particular, in this implementation, in response to the actual cumulative tool load experienced by the cutting tool approaching and/or falling within a threshold deviation of the target cumulative tool load defined for the cutting tool for this tool-cutting process, the computer system can automatically update the set of operating parameters in order to limit and/or minimize additional tool load experienced by the cutting tool during a remainder of the tool-cutting process. The computer system can therefore update these operating parameters—in (near) real-time—in order to prevent the (actual) cumulative tool load from exceeding the target cumulative tool load defined for the tool-cutting process.

For example, during execution of a first instance of the tool-cutting process, the computer system can: access a target cumulative tool load-experienced by the cutting tool during execution of an instance of the tool-cutting process—defined for the tool-cutting process based on a baseline load profile generated for the tool-cutting process (e.g., as described above); trigger the automated machine to execute the first instance of the tool-cutting process according to a first set of operating parameters, such as including a first feed rate and a first cutting speed; leverage timeseries load data output by the automated machine to track a cumulative tool load experienced by the first cutting tool; predict a final cumulative tool load for the first cutting tool upon completion of the first instance of the first tool-cutting process based on the cumulative tool load and the baseline load profile, such as based on trends depicted in the baseline load profile; and characterize a difference between the final cumulative tool load and the target cumulative tool load. Then, in response to the difference falling below a threshold difference—such that the final cumulative tool load is predicted to exceed the target cumulative tool load—the computer system can: automatically select a second set of operating parameters—such as including a second feed rate and a second cutting speed—predicted to reduce the final cumulative tool load; and trigger the automated machine to implement the second set of operating parameters in replacement of the first set of operating parameters.

Additionally or alternatively, in this implementation, in response to the actual cumulative tool load experienced by the cutting tool approaching and/or falling within a threshold deviation of the threshold cumulative tool load—corresponding to a maximum tool life of the cutting tool—the computer system can automatically update the set of operating parameters in order to limit and/or minimize additional tool load experienced by the cutting tool during a remainder of the tool-cutting process. The computer system can therefore update these operating parameters—in (near) real-time—in order to prevent the (actual) cumulative tool load from approaching, meeting, and/or exceeding the threshold cumulative tool load defined for the cutting tool, thereby minimizing risk associated with tool breakage and/or damage.

For example, during execution of a first instance of the tool-cutting process, the computer system can: access a threshold cumulative tool load defined for the cutting tool (e.g., as described above); trigger the automated machine to execute a first instance of the tool-cutting process according to a first set of operating parameters (e.g., cutting speed, feed rate, depth of cut); leverage timeseries load data output by the automated machine to track a cumulative tool load experienced by the cutting tool; and characterize a difference between the cumulative tool load and the threshold cumulative tool load. Then, in response to the difference falling below a threshold difference—such that the cumulative tool load is predicted to approach (e.g., fall within a threshold), equal, and/or exceed the threshold cumulative tool load—the computer system can: automatically select a second set of operating parameters predicted to reduce tool load experienced by the tool and therefore limit additional tool load experienced by the cutting tool during a remainder of the tool-cutting process; and trigger the automated machine to implement the second set of operating parameters in replacement of the first set of operating parameters.

The systems and methods described herein can be embodied and/or implemented at least in part as an automated machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as an automated machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during an initial time period:
accessing a corpus of machining data representing combinations of a host of features and machining strategies for machining the host of features; and
training a strategy-generating model on the corpus of machining data to generate recommended machining strategies for machining a population of features based on feature characteristics of features in the host of features; and
during a first time period succeeding the initial time period:
receiving a request for a machining strategy for machining a part defining a set of features;
for a first feature, in the set of features, accessing a first set of feature characteristics defined for the first feature;
representing the first set of feature characteristics in a first feature container associated with the first feature;
based on the first feature container and the strategy-generating model:
generating a set of recommended machining strategies for machining the first feature, each recommended machining strategy, in the set of recommended machining strategies, defining a sequence of machining operations and a set of operation parameters for each machining operation in the sequence of machining operations; and
for each recommended machining strategy in the set of recommended machining strategies, generating a rationale, in a set of rationale, for selection of the machining strategy based on a set of strategy metrics; and
serving the set of recommended machining strategies, paired with the set of rationale, to a user associated with the request.

2. The method of claim 1, further comprising:
accessing a corpus of historical machining data representing combinations of features and corresponding machining strategies implemented at a facility associated with the user;
updating the strategy-generating model based on the corpus of historical machining data; and
in response to selection of a first recommended machining strategy, in the set of recommended machining strategies, by the user:
storing the first recommended machining strategy in a set of selected machining strategies selected by the user for machining the set of features of the part;
representing the first set of characteristics of the first feature in a training feature container;
representing a first sequence of operations defined by the first recommended machining strategy in the training feature container;
representing a first set of operation parameters defined for the first sequence of operations in the training feature container; and
updating the strategy-generating model based on the training feature container to generate recommended machining strategies for machining features based on characteristics of features, historical machining data associated with the facility, and preferences of the user.

3. The method of claim 1, further comprising, in response to selection of a first recommended machining strategy, in the set of recommended machining strategies, by the user, the first recommended machining strategy defining a first sequence of machining operations:
accessing a suite of tools accessible for execution of machining operations at a machining facility associated with the user; and
for a first machining operation, in the first sequence of machining operations, defined for the first recommended machining strategy:
accessing a first tool type defined for the first machining operation;
based on the suite of tools and the first tool type, selecting a first subset of tools, in the suite of tools, of the first tool type and predicted to achieve a target outcome during execution of the first machining operation; and
serving the first subset of tools to the user via the user portal.

4. The method of claim 1:
wherein accessing the corpus of machining data comprises accessing a corpus of feature containers, each feature container, in the corpus of feature containers, containing:
a set of feature data representative of characteristics of a particular feature in the set of features; and
a set of strategy data representative of a sequence of operations defined by a particular machining strategy for machining the particular feature; and
wherein training the strategy-generating model on the corpus of machining data comprises training the strategy-generating model on the corpus of feature containers.

5. The method of claim 1:
wherein receiving the request for the machining strategy for machining the part comprises receiving the request for the machining strategy for machining the part and comprising a 3-dimensional representation of the part; and
wherein accessing the first set of feature characteristics of the first feature:
identifying the set of features represented in the 3-dimensional representation; and
extracting the first set of feature characteristics of the first feature, in the set of features, based on data extracted from the 3-dimensional representation.

6. The method of claim 1:
wherein accessing the first set of feature characteristics defined for the first feature comprises accessing the first set of feature characteristics defined for the first feature comprising a hole, the first set of feature characteristics comprising a hole type and a set of hole dimensions; and
wherein generating the set of recommended machining strategies for machining the first feature comprises generating the set of recommended machining strategies for machining the first hole, the set of recommended machining strategies comprising:
a first recommended machining strategy defining:
a first centering operation defining a first set of centering parameters; and
a first roughing operation defining a first set of roughing parameters; and
a second recommended machining strategy defining:
a second centering operation defining a second set of centering parameters;
a second roughing operation defining a second set of roughing parameters; and
a finishing operation defining a set of finishing parameters.

7. The method of claim 6:
wherein generating the first recommended machining strategy for machining the first hole comprises generating the first recommended machining strategy defining:
the first centering operation defining the first set of centering parameters comprising:
a first machining operation type of pre-drilling; and
a first tool type of center drill; and
the first roughing operation defining the first set of roughing parameters comprising:
a second machining operation type of drilling; and
a second tool type of drill; and
wherein generating the second recommended machining strategy for machining the first hole comprises generating the second recommended machining strategy defining:
the second centering operation defining the second set of centering parameters comprising:
the first operation type of pre-drilling; and
the first tool type of center drill;
the second roughing operation defining the second set of roughing parameters comprising:
the second operation type of drilling; and
the second tool type of drill; and
the finishing operation defining the set of finishing parameters comprising:
a third operation type of bore milling; and
a third tool type of flat end mill.

8. The method of claim 1:
wherein accessing the first set of feature characteristics of the first feature comprises accessing the first set of feature characteristics comprising a first feature type, a first feature material, and a first set of feature dimensions defined for the first feature; and
wherein representing the first set of feature characteristics in the first feature container associated with the first feature comprises:
initializing the first feature container for the first feature;
representing the first feature type in a first data slot in the first feature container;
representing the first feature material in a second data slot in the first feature container; and
representing the first set of dimensions in a third data slot in the first feature container.

9. The method of claim 1:
wherein generating the set of recommended machining strategies comprises generating a first recommended machining strategy defining:
a first sequence of operations for machining the first feature; and
a first set of operation parameters for executing the first sequence of operations, the first set of operation parameters comprising a set of tool types, each tool type, in the set of tool types, corresponding to a particular operation in the first sequence of operations; and
wherein generating the rationale, for each recommended machining strategy, in the set of recommended machining strategies, comprises generating a first rationale for the first recommended machining strategy, the first rationale defining a first set strategy metrics associated with tool life of tools of the set of tool types defined by the first recommended machining strategy.

10. The method of claim 1:
wherein serving the set of recommended machining strategies to the user comprises serving the set of recommended machining strategies to the user via a user portal accessed by the user; and
further comprising, in response to rejection of the set of recommended machining strategies by the user:
generating a prompt to manually enter a new machining strategy for machining the first feature of the part;
transmitting the prompt to the user via the user portal; and
in response to receipt of the new machining strategy generated by the user:
storing the new machining strategy in a set of selected machining strategies selected by the user for machining the set of features of the part; and
updating the strategy-generating model based on rejection of the set of recommended machining strategies, the new machining strategy entered by the user, and the first set of feature characteristics of the first feature.

11. The method of claim 1, wherein generating the set of recommended machining strategies for machining the first feature based on the first feature container and the strategy-generating model comprises:
accessing a facility profile, in a population of facility profiles, generated for a machining facility affiliated with the user;
extracting a suite of tools defined in the facility profile and available at the machining facility; and
based on the first feature container, the suite of tools, and the strategy-generating model, generating the set of recommended machining strategies for machining the first feature, each recommended machining strategy, in the set of recommended machining strategies, defining:
a sequence of operations for machining the first feature; and
for each machining operation, in the sequence of operations, a set of operation parameters comprising a tool type for implementing during execution of the operation, the tool type represented in the suite of tools.

12. The method of claim 1, further comprising, in response to selection of a first recommended machining strategy, in the set of recommended machining strategies, by the user:
storing the first recommended machining strategy in a set of selected machining strategies selected by the user for machining the set of features of the part;
generating a set of code defining instructions for executing the set of selected machining strategies to machine the part at an automated machine installed in a machining facility affiliated with the user; and
triggering the automated machine to execute the set of code to machine the part according to the set of selected machining strategies.

13. The method of claim 1:
wherein generating the set of recommended machining strategies for machining the first feature comprises generating a first recommended machining strategy for machining the first feature, the first recommended machining strategy defining:
a first machining operation; and
a first set of operation parameters for the first machining operation and comprising a first tool for completing the first machining operation;
wherein generating a rationale for each recommended machining strategy, in the set of recommended machining strategies, for selection of the machining strategy comprises generating a first rationale for the first recommended machining strategy, the first rationale defining a first predicted torque exerted on the first tool during execution of the first machining operation; and
further comprising, in response to selection of the first recommended machining strategy, in the set of recommended machining strategies, by the user:
accessing a timeseries of load data captured at an automated machine configured to machine the part and representing change in torque exerted on the first tool during execution of the first machining operation at the automated machine;
deriving an average torque exerted on the first tool during execution of the first machining operation based on the timeseries of load data;
characterizing a difference between the first predicted torque and the average torque; and
based on the difference, updating the strategy-generating model.

14. The method of claim 1:
wherein receiving the request for the machining strategy comprises receiving the request for the machining strategy via an instance of a user portal executing on a computing device accessed by the user; and
further comprising, in response to selection of a first recommended machining strategy, in the set of recommended machining strategies, by the user, the first recommended machining strategy defining a first sequence of machining operations, for a first machining operation in the first sequence of machining operations:
accessing a first tool type defined for the first machining operation by the first recommended machining strategy;
selecting a first set of tools of the first tool type for executing the first machining operation;
via the user portal, serving the user an interactive feature configured to enable user selection of a set of weights assigned to a set of tool metrics for the set of cutting tools, the set of tool metrics comprising material removal rate and tool life of each cutting tool in the set of cutting tools; and
in response to a user input at the interactive feature:
assigning a first weight to material removal rate of the set of tools based on the user input;
assigning a second weight to tool life of the set of cutting tools based on the user input; and
for a first cutting tool in the set of cutting tools:
accessing a set of tool characteristics defined for the first cutting tool;
based on the first weight, the second weight, the set of tool characteristics, defining a first set of tool operating parameters for the first cutting tool comprising a first cutting speed and a first feed rate;
predicting a first average torque experienced by the first cutting tool during execution of the first machining operation based on the first set of tool operating parameters; and
predicting a first tool life of the first cutting tool based on the first average torque; and
serving the first cutting tool, the first set of tool operating parameters, the first average torque, and the first tool life to the user via the user portal.

15. A method comprising:
receiving a request for a machining strategy for machining a part defining a set of features via a user portal accessed by a user associated with a machining facility;
accessing a first set of feature characteristics defined for a first feature in the set of features;
retrieving a strategy-generating model configured to output recommended machining strategies for machining a population of features based on characteristics of features in the population of features;
based on the first set of feature characteristics and the strategy-generating model, generating a set of recommended machining strategies for machining the first feature, each recommended machining strategy, in the set of recommended machining strategies, defining:
a sequence of machining operations; and
for each machining operation, in the sequence of machining operations, a tool type for executing the machining operation;
serving the set of recommended machining strategies to the user via the user portal; and
in response to selection of a first recommended machining strategy, in the set of recommended machining strategies, by the user via the user portal, the first recommended machining strategy defining a first sequence of machining operations:
accessing a suite of cutting tools accessible for execution of machining operations at the machining facility; and
for a first machining operation, in the first sequence of machining operations, defined for the first recommended machining strategy:
accessing a first tool type defined for the first machining operation by the first recommended machining strategy;
based on the suite of tools and the first tool type, selecting a first subset of tools, in the suite of tools, of the first tool type and predicted to achieve a set of target metrics during execution of the first machining operation at the automated machine; and
serving the first subset of tools to the user via the user portal.

16. The method of claim 15:
further comprising, during an initial time period:
accessing a corpus of machining data representing combinations of a set of features and machining strategies for machining the set of features; and
training the strategy-generating model on the corpus of machining data to generate recommended machining strategies for machining a population of features based on characteristics of features in the population of features;
wherein receiving the request via the user portal comprises, at a first time during a first time period succeeding the initial time period, receiving the request via the user portal;
wherein serving the first subset of tools to the user via the user portal comprises, at a second time succeeding the first time and during the first time period, serving the first subset of tools to the user via the user portal;
wherein selecting the first subset of tools of the first tool type and predicted to achieve the set of target metrics during execution of the first machining operation at the automated machine comprises, for a first cutting tool of the first tool type, predicting a first set of target metrics for the first cutting tool comprising:
a first target average torque experienced by the first cutting tool during execution of the first machining operation; and
a first target tool life of the first cutting tool executing the first machining operation; and
further comprising:
in response to selection of the first tool, in the first subset of tools, by the user via the user portal, updating the first recommended machining strategy, selected by the user, to define the first tool paired with the first machining operation; and
during a second time period succeeding the first time period:
triggering the automated machine to machine the first feature according to the first recommended machining strategy via the first cutting tool;
accessing a set of metrics derived for the first cutting tool during execution of the first machining operation at the automated machine;
characterizing a difference between the first set of target metrics and the set of metrics; and
updating the strategy-generating model based on selection of the first recommended machining strategy by the user and the difference.

17. The method of claim 15:
wherein accessing the suite of cutting tools comprises:
accessing a facility profile, in a population of facility profiles, associated with the machining facility and defining a first set of local cutting tools available for machining parts at the machining facility; and
accessing a catalog of global cutting tools available external the machining facility; and
wherein selecting the first subset of tools, in the suite of tools, of the first tool type comprises:
selecting a first subset of local cutting tools, in the first set of local cutting tools, of the first tool type; and
selecting a second subset of global cutting tools, in the catalog of global tools, predicted to achieve a target performance.

18. The method of claim 15, further comprising, for each cutting tool in the first subset of cutting tools:
accessing a set of tool characteristics of the cutting tool;
deriving a set of tool parameters for the cutting tool based on the set of tool characteristics, the set of tool parameters comprising a cutting speed and a feed rate; and
based on the set of tool parameters, predicting a set of tool metrics for the cutting tool executing the first machining operation, the set of tool metrics comprising:
an average torque experienced by the cutting tool during execution of the first machining operation; and
a tool life of the cutting tool executing the first machining operation.

19. A method comprising:
receiving a request for a machining strategy for machining a part defining a set of features from a user associated with a machining facility;
for a first feature, in the set of features, accessing a first set of feature characteristics defined for the first feature;
accessing a facility profile, in a population of facility profiles, associated with the machining facility and defining a suite of cutting tools available for machining parts at the machining facility;
retrieving a strategy-generating model configured to output recommended machining strategies for machining a population of features based on characteristics of features in the population of features;
based on the first set of feature characteristics, the suite of cutting tools, and the strategy-generating model:
deriving a set of recommended machining strategies for machining the first feature, each recommended machining strategy, in the set of recommended machining strategies defining a sequence of operations and a set of operation parameters for each machining operation in the sequence of operations; and
for each recommended machining strategy in the set of recommended machining strategies, deriving a rationale, in a set of rationale, for selection of the machining strategy based on a set of strategy metrics; and
serving the set of recommended machining strategies, paired with the set of rationale, to the user.

20. The method of claim 19, further comprising:
during an initial time period:
accessing a corpus of machining data representing combinations of a set of features and machining strategies for machining the set of features; and
training the strategy-generating model on the corpus of machining data to generate recommended machining strategies for machining a population of features based on characteristics of features in the population of features; and
in response to selection of a first recommended machining strategy, in the set of recommended machining strategies, by the user:
storing the first recommended machining strategy in a set of selected machining strategies selected by the user for machining the set of features of the part; and
updating the strategy-generating model based on the set of selected machining strategies.
